(19) United States
(12) Patent Application Publication
(10) Pub. No.: US 2025/0157295 A1
(43) Pub. Date: May 15, 2025

(54) WAGER MATRIX WITH MULTIPLE BETTING PARAMETERS

(71) Applicant: CG TECHNOLOGY, L.P., NEW YORK, NY (US)

(72) Inventors: Matthew Holt, Las Vegas, NV (US); Quinton Singleton, Las Vegas, NV (US); Ken Perrie, Coconut Creek, FL (US); Todd Fishon, Henderson, NV (US)

(21) Appl. No.: 19/019,709

(22) Filed: Jan. 14, 2025

Related U.S. Application Data
(63) Continuation of application No. 17/849,853, filed on Jun. 27, 2022.
Application No. 17/849,853 is a continuation of application No. 14/779,863, filed on Mar. 24, 2016, now abandoned.
(60) Provisional application No. 62/040,702, filed on Aug. 22, 2014.

(51) Int. Cl. G07F 17/32

(52) U.S. Cl. CPC G07F 17/3244; G07F 17/3218; G07F 17/3239; G07F 17/3258; G07F 17/3262; G07F 17/3267; G07F 17/3288; G07F 17/329

(57) ABSTRACT

Various systems and methods enable users to submit bets via a betting matrix comprising a plurality of rows and columns. Each row corresponds to a potential outcome in a first category such as a possible score of a first team, and each column corresponds to a potential outcome in a second category such as a possible score of a second team. A user may enter a bet, e.g., by selecting one or more events and then selecting one or more elements of one or more betting matrices corresponding to the one or more events. The bets may be confirmed substantially when entered, e.g., without regard for any other bet made by any other user.

### CROSS REFERENCE TO RELATED APPLICATIONS

This application is a continuation of U.S. patent application Ser. No. 17/849,853 filed Jun. 27, 2022, which is a continuation of U.S. patent application Ser. No. 14/779,863 filed Mar. 24, 2016, which is a U.S. National Stage Entry of PCT/US2014/057799 filed Sep. 26, 2014, which claims the benefit of U.S. Provisional Patent Application No. 61/882,732 filed Sep. 26, 2013, and U.S. Provisional Patent Application No. 62/040,702 filed Aug. 22, 2014, each of which is incorporated by reference herein in its entirety.

### TECHNICAL FIELD

Some embodiments relate to wagering on one or more outcomes related to one or more events.

### BACKGROUND

Various types of games are known.

### SUMMARY

Various systems and methods enable users to submit bets via a betting matrix comprising a plurality of rows and columns. Each row may correspond to a potential outcome in a first category such as a possible score of a first team. Each column may correspond to a potential outcome in a second category such as a possible score of a second team. A user may enter a bet, e.g., by selecting one or more events and then selecting one or more elements of one or more betting matrices corresponding to the one or more events. The bets may be confirmed substantially when entered, e.g., without regard for any other bet made by any other user.

Various embodiments are directed to apparatuses, methods, and computer-readable media that enable the following actions to take place. A request to submit a wager may be received from a first user. Responsive to the request a first betting matrix comprising a plurality of selectable elements arranged in rows and columns may be communicated to the first user. A first bet comprising a selection by the first user of a first one of the plurality of selectable elements may be received from the first user. The first selected element may be in a selected one of the rows and in a selected one of the columns. Responsive to receiving the first bet, a confirmation that the first bet is in effect may be communicated to the first user. A payout may be paid on the first bet if the first bet is a winning bet. Betting category information associated with the first betting matrix may be communicated to the first user. The category information may comprise a first category of possible outcomes corresponding to the rows and a second category of possible outcomes corresponding to the columns. Possible outcome indicia indicating a plurality of possible outcomes associated with the rows and columns of the first betting matrix may be communicated to the first user. The possible outcome indicia may comprise (1) for each row, indicia indicating a respective possible outcome of the first category corresponding to said row and (2) for each column, indicia indicating a respective possible outcome of the second category corresponding to said column. The first selected element may correspond to both (a) the respective possible outcome of the first category corresponding to the selected row and (b) the respective possible outcome of the second category corresponding to the selected column. A first actual outcome corresponding to at least one of the possible outcomes of the first category and a second actual outcome corresponding to at least one of the possible outcomes of the second category may be determined. Responsive to determining a first actual outcome and a second actual outcome, information indicating whether the first bet is a winning bet may be communicated to the first user.

According to an aspect of the present disclosure a method is disclosed including transmitting to a user device a list of events, receiving from the user device an activation of an event of the list of events, transmitting a betting matrix having at least one two sides to the user device, receiving from the user device an activation of at least one betting box of the betting matrix, generating side values for each side of the betting matrix, receiving an event outcome, determining whether the event outcome matches the at least one activated betting box, and if the event outcome is determined to match the at least one activated betting box, transmitting to the user device a prize notification indicating a prize for matching the outcome to the betting box.

The above advantages and features are of representative embodiments only and are presented only to assist in understanding the invention. They are not to be considered limitations on the invention as defined by the claims. Additional features and advantages of embodiments of the invention will become apparent in the following description, from the drawings, and from the claims.

### BRIEF DESCRIPTION OF THE DRAWINGS

FIG. 1 depicts a system diagram of an event system in accordance with an embodiment of the present disclosure;

FIG. 2 depicts a flow chart of a method of providing a system for betting on intermediate and/or final outcomes of an event in accordance with an embodiment of the present disclosure;

FIGS. 3-9 depict user interface views in accordance with various exemplary embodiments;

FIGS. 10 and 11 are user interface views in accordance with various exemplary embodiments;

FIGS. 12-19 depict exemplary betting matrices and interface views according to various embodiments; and

FIG. 20 depicts an exemplary flow chart according to an embodiment.

### DESCRIPTION

The present disclosure provides systems and methods for betting on intermediate and/or final outcomes of an event. The bet may include wagers, fantasy sports bets, points bets, fun bets with no monetary attachment, free to play, entry fee based bets, donations, contests, or other similar bets, or a combination thereof. For example, a winner of a bet may win a payout, points, giveaways or prizes, or other similar winnings from the event venue. A user may play a betting game using points, for example, by paying or risking some points to win a prize (e.g., more points, a monetary prize, etc.). A user may play a betting game for a chance to win notoriety in addition to and/or as an alternative to winning some other prize. For example, a winner of a betting game may be named a best player in a public manner in lieu and/or in addition to receiving a monetary prize. A betting game may include a game that has elements that are based at least in part on one or more of skill and luck.

In some embodiments, a sports wagering system is provided that allows an individual to participate in a game of chance by initiating a wager based on the final score of a sporting contest using the single digit number of the score of the game as the basis for the outcome. A single digit number from 0 to 9 for each team participating in the contest will be randomly assigned and the score at predetermined intervals will serve as the results to determine the wager.

Various embodiments generally relate to a sports wagering system where a host system electronically initiates a single digit number assigned to each team participating in a contest which will be used to initiate a wager based on the score of the game at predetermined intervals.

In the past, a popular wagering structure for gambling on the outcome of a sporting event, most notably a high profile football game has been the formation of a box pool. This can be an exciting way to engage in a wager on a sporting event without having to select a team to win; the results are strictly a random chance on the outcome of the numerical score of a contest. A box pool can be a ten by ten grid that produces 100 boxes where each individual can select a box by assigning their name within the box. After all 100 boxes are assigned, each row and column, with the horizontal axis representing one team and the vertical axis representing the other team, are randomly assigned a single digit number from 0 to 9. Specifically, each row will have a unique number from 0 to 9 and each column will have a unique number from 0 to 9. Once each row and column has their respective numbers, the players can determine their individual combination by locating their selected box and. linking the corresponding numbers associated with the column and row in which their box resides.

In some cases, once a player determines their number associated with each team, they will win if at the predetermined intervals of the sports contest, the single digit number representing each contestant matches their numbers. An example would be if a player had 6 for team A and 4 for team B and the final score of the game was 26 for team A and 14 for team B, the single digit number representing the final score would be 6 for team A and 4 for team B resulting in a win for the player with the team A 6 and team B 4 combination.

American football is a popular sporting event for these types of box pools, and the organizer typically determines the payout structure. In some instances, the prize pools can be distributed solely to the final score.

In some embodiments, payouts may be distributed for each quarter, and in other embodiments payouts may be earned and/or paid after each score change.

In some cases, the work involved to fill each of the 100 boxes, collect the money, and distribute the money can be burdensome, and other difficulties arise if the box pool is not completely filled. Other disadvantages in some systems are the frequency and availability of accessing a pool as well and the amount of money needed to wager.

One embodiment of the invention may comprise an electronic betting unit or web based application that offers a variety of sporting events where a player can choose to initiate a wager based on the score of the event at predetermined periods. The player can choose the event, the betting limit, the frequency of opportunities to win, and how many number combinations (boxes) they want to wager on. This allows a player to directly control the volatility of their wagering experience. This enables a player to participate in this wagering activity regardless of how many other participants are playing and allows participation on the sporting event that the players chooses.

In some embodiments, the gaming system may offer payouts commensurate with the wager that is made, and each wager is charged a commission for the service. An example of this would be a $1 wager made on the final score of a contest with a lot of 100 chance to win would pay back $100 (99 to 1 odds). The player would pay $1.05 to make the wager; the $1.00 to initiate the wager and a 5% commission for the service. A secondary option is where a commission is garnered by not paying the true odds of the wager such as a wager with a 1 in a 100 chance to win and instead of a 99 to 1 payout; the payout is 90 to 1.

In some embodiments, a plurality of bets (e.g., from multiple users) may be pooled together, and payouts may be paid via a pari-mutuel betting rules. In other embodiments, payouts may not be paid from a pari-mutuel pool.

In some embodiments, the player can either make their wager through an appointed representative of the host system (e.g., via a betting terminal), directly through a betting terminal, or through a web-based application. A menu may direct the player to select one or more of the events (e.g., sporting event), type of wagering structure, and amount of wager and the player will receive a betting voucher with relevant information about the wager. The computer may randomly select the numbers for each of the contest's participants. Options may include a visual display of a ten by ten grid where the player can choose which box or boxes they will wager on, and each column and row will be randomly selected a number.

In one example embodiment the game, the players will have the ability to select one game at a time to initiate a wager. In another embodiment of the game, players can link multiple games together and will select one box. Each game will be randomly assigned numbers for each of the rows and columns for each game and the final score will decide each game. The payout of the wager will be determined by how many games were linked together and how many games successfully ended with the numbers assigned to the selected box.

Another embodiment of the game will allow a player to wager on the outcome of a tournament where their participants of the tournament will be placed in the cells on the vertical and horizontal axis and the participants that finish in first and second place will determine the outcome of the pool.

In some embodiments, a wager may be placed in a pool by first selecting a sporting contest from the games that are available and to select the amount of money each box represents, the frequency of determining an outcome from defined options, and which box or boxes will represent the player's numbers. After the player accepts the wager, the numbers for each cell in each row and column representing the horizontal and vertical axis on the grid will be randomly chosen. The player's numbers for each team will be determined by the location of their box and the intersection are each axis where the box is located.

In another embodiment, a wager may be placed in the pool by selecting two or more games where the wager will be linked to multiple games. The payouts may be based on how many of the games correctly ended with the numbers correlating to the player's box(es). Each box the player selects constitutes one wager.

One method of placing a wager in the pool is to select a tournament such as the World Cup where teams are segmented into brackets where one person from each bracket will play in the final match.

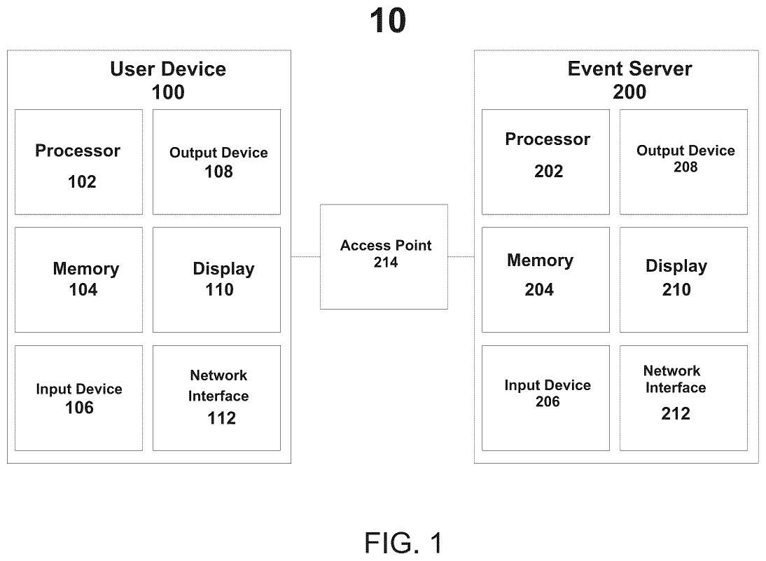

Referring now to FIG. 1, a system 10 is disclosed including one or more user devices 100 and one or more event servers 200. User devices 100 may be, for example, desktop computers, mobile devices, mobile gaming devices, cellular telephones, smart phones, tablets, laptops, or other similar user devices that allow users or players to access system 10. User devices 100 may also or alternatively include terminals or kiosks located at an event venue, for example, a sporting event arena, outdoor venue, concert hall, film set, or other similar event venues. Terminals or kiosks may also or alternatively be located offsite, for example, at a casino, betting parlor, bar/pub, restaurant, or other similar locations. The terminals or kiosks may be located at various locations throughout the event location or alternatively may be present at and/or integrated into a seat of the user or player. For example, the terminals or kiosks may be located near an entrance to the event venue, near concessions, or in other similar common areas throughout the event venue. Terminals or kiosks may be self-service. The terminals or kiosks may also or alternatively be located at betting locations where, for example, a user or player informs an operator of the bet to be made, and the operator enters the bet into the terminal or kiosk for the user or player. The user or player may then utilize a personal user device 100, a user device 100 provided by the event venue, or a user device 100 provided by the offsite location to review and track the user or player's bets.

User devices 100 each may include at least one processor 102, memory 104, input device 106, output device 108, display 110, network interface 112, and other similar features commonly found in user devices. Input device 108 may include, for example, a keyboard, mouse, button, microphone, or other similar input devices. Input device 108 may also or alternatively be integrated into display 110 as a touch sensitive display. Output device 106 may be any form of output including, for example, speakers, vibrators, display 110, or other similar output features commonly found on user devices. Display 110 may be configured to present a user interface to a user or player and may be touch sensitive. Network interface 112 is configured to enable communication between user devices 100 and event server 200 and may include a wired connection, wireless connection, or both a wired and wireless connection. Examples of wireless connections may include, for example, Bluetooth®, Wi-Fi, mobile networks, satellite, and other similar methods of wireless communication.

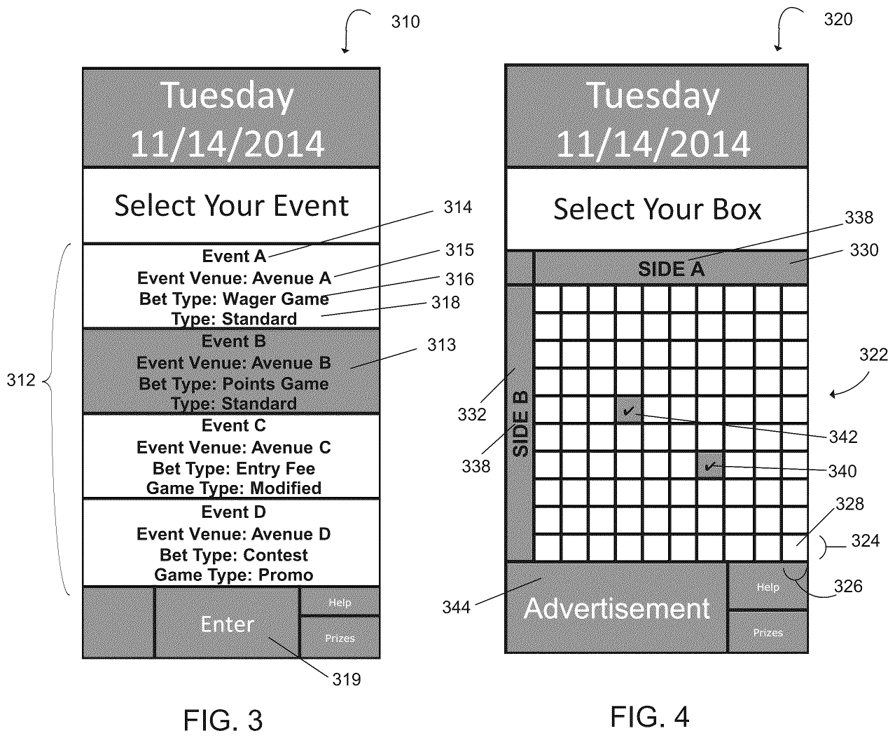

Memory 104 may include a program or application, for example, a gaming or contest application, that, when executed by the processor 102 causes the processor to present a user interface 300 (FIG. 3) to a user or player of the user device 100 for placing bets. The application may also or alternatively be stored on event server 200 or integrated into a web page hosted on event server 200 that may be downloaded or accessed by user devices 100 and executed by processor 102 for presentation on display 110. The application may also or alternatively be stored on a non-transitory computer readable medium and configured for execution by the user device 100.

Event server 200 may include one or more servers having similar components as user devices 100 including at least one processor 202, memory 204, input devices 206, output devices 208, displays 210, network interfaces 212, and other similar features commonly found on servers, and as described above with respect to user devices 100. For example, memory 204 may include the gaming or contest application as described above with respect to memory 104. Event server 200 may be located at the event venue, may be located at a remote location from the event venue, or may be a cloud based server. The event venue may also include one or more access points 214 that provide wired or wireless access to users or players within the event venue and connects the user devices 100 of users or players at the event venue to the event server 200. For example, network interfaces 112 and 212 of user devices 100 and event server 200 respectively may connect to access point 214. Although system 10 is described as connecting user devices 100 to event server 200 via an event venue provided access point 214, as shown, for example, in FIG. 1, it is contemplated that user devices 100 may directly connect to event server 200 or may alternatively connect to event server 200 via other non-venue access points, mobile communications systems, and/or the internet.

Event server 200 may be configured to determine the location of user devices 100, for example, by using GPS, signal triangulation, geo-fencing, or other similar methods of location determination. As another example, event server 200 may determine location of the user devices 100 by determining whether or not the user devices 100 are connected to one of access points 214 at the event venue or to an access point at an offsite location. Determining the locations of the user devices 100 assists the event server 200 in maintaining control over which user devices 100 can access the application and/or what prizes or giveaways the users or players of the user devices 100 are eligible to win. For example, if the event organizer wants only those users or players who are present at the event venue to have access to the game, the event organizer may set an access restriction on event server 200 that requires a determination of location which may be used to enforce this access restriction.

In addition or alternatively, the event organizer may vary the available prizes or giveaways based on the location of the user devices 100. For example, if a user or player has a user device 100 that is determined to be located within or about the event venue, e.g., within the event venue, on the property, in the parking lot, or other similar event venue related locations, the user or player may be eligible to win prizes or giveaways at the event venue such as, for example, gift cards or coupons to shops or concessions located at the event venue, team jerseys, paraphernalia, or souvenirs from the event venue, prizes from sponsors of the event venue, tickets to future events at the event venue, discounts on tickets to future events at the event venue, airline tickets, vacations, or other similar giveaways.

On the other hand, user devices 100 that are not located at the event venue may only be eligible to win a subset of the above prizes, for example, gift cards to shops or concessions located at the event, tickets, or discounts on future tickets to the event venue, or other similar prizes. As an example, the available prizes for the users or players of user devices 100 that are not located at the event venue may be tailored or used by the event organizer to draw in additional customers for future events at the event venue. It is also contemplated that users or players of user devices 100 that are not located at the event venue may still be eligible to win any of the prizes that are available to users or players of user devices 100 that are located at the event venue.

In addition or alternatively, users or players of user devices 100 that are not located at the event venue may instead or additionally be eligible to win alternative prizes specific to the user or player's location that would not be otherwise available to users or players located at the event venue. For example, if the user or player is located at an offsite location, event organizers of the offsite location may provide giveaways or other similar prizes specifically tailored to the offsite location. In an example, if the user or player is located at an offsite location such as a sports bar, outside betting parlor, or other similar offsite locations, the user or player may be eligible to receive giveaways such as, for example, promotional items, prizes, souvenirs, or other similar items related to the sports bar or outside betting parlor. It is contemplated that the giveaways or prizes provided by the offsite locations may also or alternatively be affiliated with the event venue. Additionally or alternative, prizes provided by the offsite locations may have no connection to the event venue.

The location of the user devices 100 may also be used by event server 200 to determine whether or not a monetary betting or wagering is permitted. For example, the location of the user devices 100 may be used to determine if the user devices 100 are in a jurisdiction, e.g., state, country, or other similar jurisdiction, that does not allow monetary bets, e.g., sports wagering, fantasy sports betting, or other similar monetary bets, and may limit the user devices 100 found in those jurisdictions to only permitted types of betting in those jurisdictions.

As another example, an event organizer may allow players outside of the legal gaming jurisdiction to play a game for fun (e.g., using points) while players inside a legal gaming jurisdiction may play the game using money. As still another example, an event organizer may offer different variations of a game that are accessible at different locations. The event server 200 may use a determined location to allow and/or restrict access to such games or game play features for example, by preventing users from entering certain games, and/or by limiting the information about games that is transmitted to users. One or more databases may correlate locations with available prizes, games, game play features, etc. An event server may reference such a database with a determined user location to determine one or more of available prizes, games, and/or game play features.

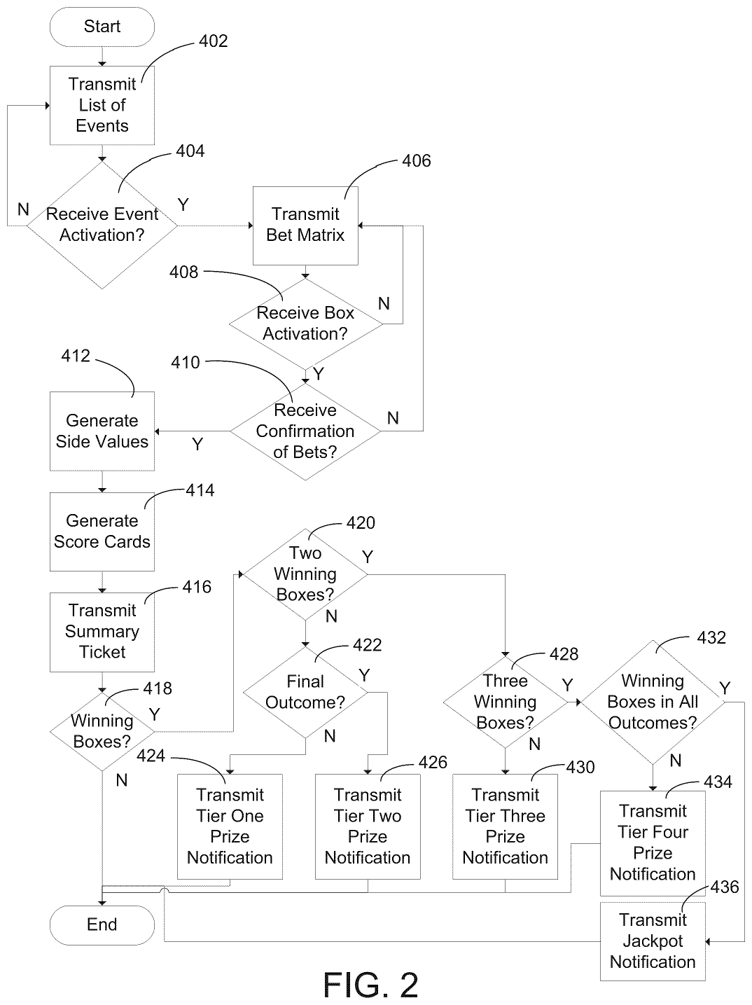

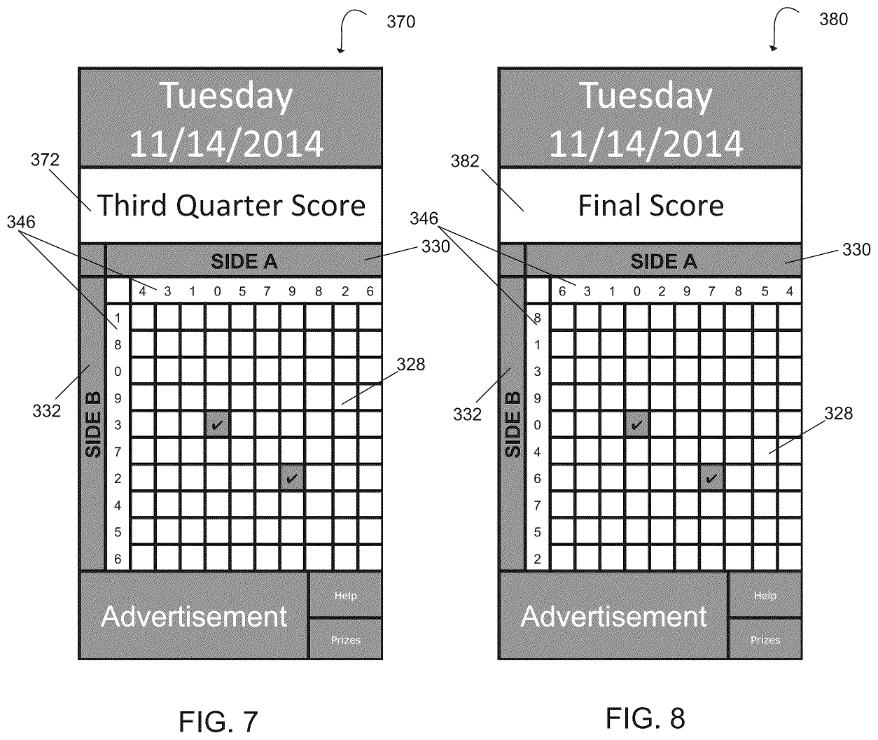

Various embodiments of a user interface 300 and methods for entering bets on one or more intermediate and/or final outcomes of one or more events will now be described with reference to FIGS. 2-11.

Referring now to FIG. 2, in some embodiments, user interface 300 may present the user or player with a view 310 in step S402 including, e.g., event information such as a list of events 312 that are available for betting, as shown in FIG. 3. The view 310 may be presented, e.g., in response to a user or player activating the application or opening a web page to access the application using a user device 100. For example, the event server 200 may receive the request to activate the application or open the web page and may transmit user interface 300 and/or view 310 including list of events 312 to user device 100 for output to display 112. The event server 200 may select or limit the list of events 312 transmitted to the user device 100 based on the location of user device 100. For example, the list may exclude certain events based on a user's location, e.g., if users in such location are not legally permitted to make a wager (e.g., as described herein) on a particular event or set of events. The event information and list of events 312 may be stored in memory 204 of event server 200 for later retrieval and transmission to user device 100. The user device 100 may also store such event information such as an event list and retrieve it, e.g., for subsequent display and/or processing.

Event information about each event 313 may comprise an event name 314, event venue 315, bet information such as a type of available bets 316, and/or game information such as the type of available games 318 (e.g., standard, modified, contest, promo, or other game types). For example, event information about one game type may include information typically used for certain types of events such as a number-based zero-to-nine score system (e.g., for bets concerning a digit, such as a bet on what will be the last digit of a score at a particular time or game state). Event information about another game type may comprise features or a score system that is less common or specifically tailored to a different kind of event or venue such as a reality TV competition (e.g., how long contestants will last in a competition, e.g., as measured in number of minutes, number of weeks of competitions, etc.), card games (e.g., two-ten, Jack, Queen, King, Ace, one to twenty-one, etc.), table games (e.g., craps, roulette, etc.), or other similar events. The event information may be stored in memory 204 of event server 200 and transmitted to user device 100, e.g., along with the list of events 312.

In step S404, the user or player may select a specific event 313 via any selection means or method, e.g., via input device 104, e.g., by highlighting or activating a specific event 313 and activating the enter option 319. Information about the event selection may then be transmitted to the event server 200. If the event organizer sets an access restriction on event server 200 to only allow those users or players that are located at the event venue to use the betting application for the event provided by the event venue, or event access is otherwise restricted, view 310 may present only the event provided by the event venue for betting, or view 310 may be skipped entirely. Alternatively, view 310 may present all available events but event server 200 may inhibit the user or player of user device 100 from activating certain events based event information, e.g., type of bets and/or games, and/or the location of user device 100. Alternatively, the user or player may still be presented with view 310 including one or more events to choose from. In some embodiments, the user may bet on multiple events, e.g., in addition to the event at the event venue where the user or player is currently located.

Once an event 313 has been selected, event server 200 may transmit a view 320 to user device 100 in step S406. The view 320 may comprise a bet matrix 322 comprising a plurality of matrix elements, wherein each matrix element corresponds to one element from a first set and one element from a second set. For example, bet matrix may comprise at least one row 324 and at least one column 326, e.g., as shown in FIG. 4. In some embodiments, view 320 may be included in the application stored on user device 100 without requiring additional transmission from event server 200. The intersection of each row 324 and column 326 forms a box 328 (or matrix of rows and columns). The bet matrix 322 may, for example, comprise a grid having perpendicular rows 324 and columns 326. Other orientations of the rows 324 and columns 326 are also contemplated without departing from the scope of the present disclosure. For example, rows 324 and columns 326 may be oriented at any other angle to one another so long as rows 324 and columns 326 intersect to form boxes 328 without departing from the scope of the present disclosure. It should be appreciated that in some embodiments, bet matrix may not comprise a rectangular array of rows and columns, and that other embodiments comprising a plurality of selectable items wherein, like a coordinate pair, each item corresponds to (1) an element of a first set (e.g., first coordinate) and (2) an element of a second set (e.g., second coordinate). For example, a box in the third row and fourth column may correspond to the third element of the first set and the fourth element of the second set; the coordinate pair (3, 4) may similarly correspond to the same elements.

In some embodiments, rows (or first coordinates) of a bet matrix may correspond to the elements of a first set, e.g., such that each row corresponds to a different element of the first set. For example, ten rows may correspond to ten digits (e.g., the digits 0-9) such that each row corresponds to a different digit. Similarly, columns (or second coordinates) of a bet matrix may correspond to the elements of a second set, e.g., such that each column corresponds to a different element of the second set. For example, ten rows may correspond to ten digits (e.g., the digits 0-9) such that each row corresponds to a different digit. The elements (e.g., digits 0-9) may be in numerical order, or another order such as a random order. In some embodiments, more than one row (or first coordinate) may correspond to the same element of the first set (e.g., if the digit “2” is used more than once in the first set and thus corresponds to more than one different row); and/or similarly, more than one column (or second coordinate) may correspond to the same element of the second set.

A bet matrix may comprise two sets of parameters or elements, such as a first set of possible event outcomes and a second set of possible event outcomes. Each set may be associated with a side, a team, a competitor, a player, an event type, and/or other game, event, or competitor information. For example, in a game of one player or team versus another player or team, one set (e.g., top side, or column values) may be associated with one player or team, and another set (e.g., left side, or row values) may be associated with the other player or team. For example, in a Giants-Eagles football game, the top side (columns) may be associated with the Giants while the left side (rows) may be associated with the Eagles.

In some embodiments, the two sets may be independent or substantially independent of one another. In some embodiments, the first set may comprise a set of mutually exclusive outcomes, and/or the second set may comprise a set of mutually exclusive outcomes. E.g., for a specific at bat during an inning of baseball, one set of mutually exclusive outcomes may comprise (1) runner walks, (2) runner strikes out, (3) runner hits a single, (4) double, (5) triple, or (6) home run. In some embodiments, the elements in a set may not be mutually exclusive. For example, in the at bat example, set elements may include (1) runner walks, (2) runner gets on first, and (3) runners at bat results in at least one scoring run before the next at bat.

For example, above bet matrix 322, a first side 330 of the bet may be provided and on the left side of the bet matrix 322 a second side 332 of the bet may be provided. As an example, a side of the bet may comprise a sports team, a player, a contestant, or any other part of an event that may be tracked and/or scored and/or otherwise determined for either intermediate or final outcomes (or other outcomes). In some embodiments, a view 321 may be presented including a third side 334 (FIG. 10) and a fourth side 336 (FIG. 10) on the right and bottom sides of the bet matrix 322 respectively, e.g., in addition to first and second sides 330, 332, e.g., depending on the type of event and the type of game. For example, a specific selection of a specific box may correspond to a specific corresponding value or element from Side A, Side B, Side C, and Side D. It should also be appreciated that opposite sides, such as Sides B and C (and also Sides A and D), may be related to one another because a selection of a specific row may define a selection corresponding to both side B and side C, and a selection of a column may define a selection corresponding to both side A and side D. For example, if the third row corresponds to the number “7” on side B and the player “Mulligan” on side C, then each box or element in the third row corresponds to the number “7” on side B and the player “Mulligan” on side C.

Each side may correspond to a set, e.g., a set of possible outcomes. For example, a first set (e.g., a set of possible outcomes) may correspond to a first side of the matrix (e.g., side A), and a second set (e.g., of possible outcomes) may correspond to a second side of the matrix (e.g., side B). In some embodiments, each side 330, 332, 334, and/or 336 may include information about the corresponding set (e.g., of possible outcomes), e.g., a name or description 338 of the side, for example, the name of a sports team, contestant, a part of an event, or a participant of the event. The number of rows 324 (or number of different first coordinates) may vary based on the number of elements (e.g., possible outcomes) in the first set corresponding to the rows. Similarly, the number of columns 326 (or number of different second coordinates) may vary based on the number of elements (e.g., possible outcomes) in the second set corresponding to the columns. Accordingly, the number of rows 324 and columns 326 may vary based on the type of event, the type of bet, the type of game, and the sides 330, 332, 334, 336, e.g., as will be described in more detail below. The event server 200 may store bet matrix 322 or information related thereto, e.g., the orientations and numbers of rows 324 and columns 326, and the sides 330, 332, 334, 336 in memory 204 along with the event information and may transmit the bet matrix 322 and sides 330, 332, 334, 336 to user device 100 along with the event information and the list of events 312. Alternatively, event server 200 may transmit the bet matrix 322 and sides 330, 332, 334, 336 to user device 100, e.g., only after the event selection has been received by event server 200 from user device 100.

In step S408, the user or player may select one or more specific elements (or specific coordinate pairs) of the betting matrix. For example, user or player may activate anyone (or more) of boxes 328 using input device 106 to place a bet, e.g., by clicking in the box.

In some embodiments, the user or player may be prompted (e.g., via display prompt, e.g., transmitted and/or triggered by user device or server) to enter a price or wager value for the bet. In some embodiments, the user or player may be prompted to enter a donation amount, pay an entry fee, enter an amount of points, or may not be required to enter or pay any amount or value to place the bet. The box activation is received by user device 100 and may be transmitted to event server 200 to log the bet. In an example, if the game type is a promo game, the user may be allowed to select a limited number of boxes to play the contest. For example, the user or player may be limited to one, two, three, or more boxes according to the settings of the promo game set by the event organizer in server 200. As shown in FIG. 4, an activated box 328 may be indicated with a symbol 340, for example, a check mark, exclamation point, “X”, or any other symbol, and also or alternatively may be indicated or highlighted with a color 342, for example, gray, green, blue, yellow, magenta, orange, red, or any other color that would contrast the activated box 328 with the rest of betting matrix 322. When the user or player has finished activating boxes 328, the user or player may confirm the bet via input device 106 in step S410. The confirmation of the bet is then transmitted from user device 100 to event server to lock in the bet. The activation of boxes 328 may be transmitted to the event server 200 separately from the confirmation or alternatively may be stored or held on user device 100 until the user or player has confirmed the bet and then transmitted to the event server 200 together. Once the event server 200 receives both the activation of boxes 328 and the confirmation of the bet from user device 100, event server 200 may determine whether or not the bet is valid. For example, event server 200 may compare the timing of the bet confirmation against a race condition, for example, a betting window, the determination of an intermediate or final outcome against which the bet was made, or other similar conditions and may allow or deny the bet accordingly. If the bet is allowed, event server 200 may store the bet in memory 204 and transmit a confirmation of the bet to user device 100. If the bet is denied, event server 200 may instead transmit a denial notification including the reasons for denial.

View 320 may also include an advertisement section 344 dedicated to advertisements where, for example, advertisements of event sponsors or other advertisers may be transmitted from server event 200 to user devices 100 for presentation to the users or players during the betting process. The advertisements may be chosen based on a variety of criteria including, for example, the location of the user device 100, the amount of money or points in the user's account, the location and/or section of the user's seat at the event venue, the game that the user or player selects, or other similar criteria. The users or players may activate advertisement section 344 using input device 106 to view more details of the advertisement from event server 200. In addition, if advertisement section 344 is activated, event server 200 or user device 100 may re-route the user or player or open a web browser page to the advertiser's web site or another site related to the advertisement.

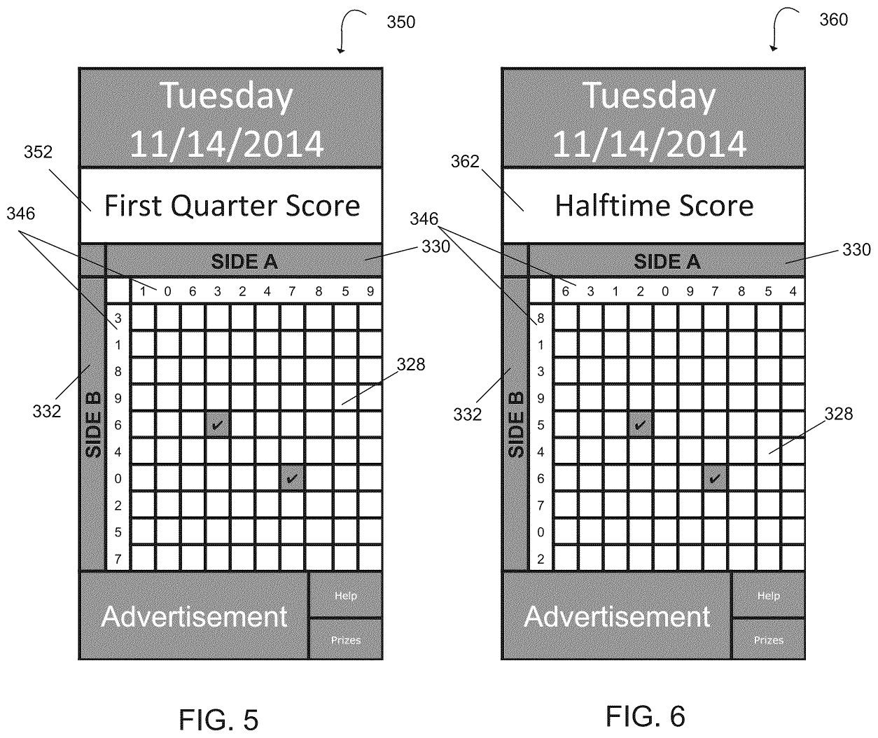

Referring now to FIGS. 5-8, in step S412 system 10 (e.g., via event server 200 or user device 100), may generate and/or otherwise determine elements of the first set and/or the second set (e.g., side values 346), e.g., in response to the player selecting or activating one or more boxes 328 and/or confirming the bets in view 320. In some embodiments, the elements may be generated and/or determined before the user makes such selection or activation.

In some embodiments, the user may make one or more selections before each matrix element value is determined (or before it is communicated to and/or known to the user) and may further one or more selections after each matrix value is determined (or after it is communicated to and/or known to the user).

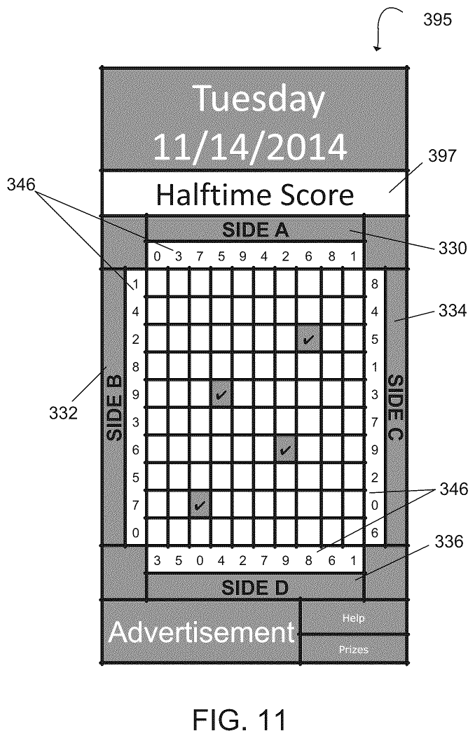

In some embodiments, side values 346 may be determined randomly, pseudo randomly, according to some algorithm, selected from a database of side values 346 and/or in any other desired manner. Event server 200 then transmits the generated side values 346 to user device 100 and user interface 300 presents views 350, 360, 370, 380, and/or 361 (FIG. 11) including score cards 352, 362, 372, 382, and 397 (FIG. 11) to the user or player in step S414, as shown in FIGS. 5-8. Score cards 352, 362, 372, 382, and 397 include the generated side values 346 which are generated by the event server 200 along the first side 330, second side 332, third side 334 (FIG. 11), and/or fourth side 336 (FIG. 11) for each intermediate or final outcome based on the type of bet, the type of event, and the type of game. The generated side values 346 may be the same for each of views 350, 360, 370, and 380, i.e., the same set of side values 346 are used for each intermediate and final outcome, or alternatively may be generated separately for each of views 350, 360, 370, and 380. The side values 346 may be randomly generated by a software based random number generator (RNG) algorithm. The side values 346 may be generated based on real-world events external to the event venue. In some embodiments, the side values 346 may be generated based on the combination of a software based RNG algorithm and real-world events external to the event venue. The side values 346 may be pre-generated and may be hidden prior to activation of boxes 328 and/or confirmation of the bets by the user or players of user device 100. For example, side values 346 may be pre-generated by event server 200 and transmitted to user device 100 along with the list of events 312.

Referring still to FIGS. 5-8, for example, the user may activate boxes 328 in view 320 and the same boxes may be used for each of views 350, 360, 370, and 380. In other embodiments, the user or player may instead separately activate boxes 328 in any or each of views 350, 360, 370, and 380 prior to the generation and/or presentation of randomized side values 346 for that view. The boxes activated in each view may be the same or may be different. In some embodiment, the user or player may activate boxes 328 in any of views 350, 360, 370, or 380 at any time prior to the intermediate or final outcome of the event corresponding to the particular view 350, 360, 370, or 380. As an example, the user or player may wish to only place a bet on the third quarter of a sporting event. In this example, the user or player may choose to activate boxes 328 in view 370 at a time up to and until the end of the third quarter of the sporting event at which point the outcome of the third quarter has been determined. In some embodiments, once the user or player has confirmed the bets using input device 106, the side numbers 346 may be generated as described above. It is also contemplated that the player may place a bet by activating a box 328 in any of views 320, 350, 360, 370, or 380 after the corresponding intermediate or final outcome has occurred. This would not impact the odds of the bet since the side values 246 may be revealed and/or generated only after the boxes 328 are activated and the user or player has confirmed the bets. In other embodiments, there may be some betting window that ends before the intermediate or final outcome is determined (e.g., one minute before the end of an intermediate or final portion of the game, one minute before the start of a game or an intermediate portion of the game, etc.)

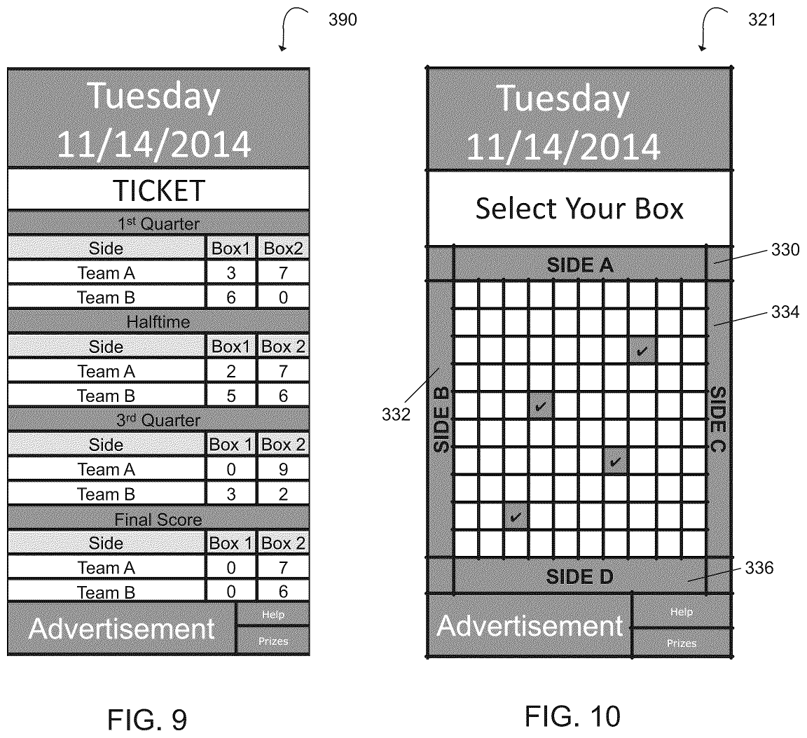

In response to a bet having been confirmed with event server 200 and the side values 346 having been revealed and/or generated, event server 200 may transmit a view 390 to user device 100 for presentation by user interface 300 in step S416, as shown, for example, in FIG. 9. View 390 provides the user or player with a summary of the current bets that have been placed by that user or player for each intermediate and final outcome.

In response to an intermediate or final outcome for the event occurring, system 10 (e.g., event server 200 or user device 101) determines whether the user or player has won in step S418 by comparing the outcome to the user or player's activated boxes 328. When one or more of a user or player's boxes 328 match the intermediate or final outcome of the event, the user or player may be awarded a prize or payout according to the bet type 316 (FIG. 3) and game type 318 (FIG. 3) of the activated event 313 (FIG. 3). For example, if the outcome of the first quarter has SIDE A (team A) with thirteen points and SIDE B (team B) with sixteen points, a first box 328, e.g., box 1, (FIGS. 5 and 9) matches the outcome where the match is based on the one's column of the numbers, and the user or player is determined by event server 200 or user device 100 to be a winner.

If the user or player is determined to be a winner, for example, the user or player may win a payout based on the odds of the intermediate or final outcome matching the user or player's box. As a non-limiting example, where there are 100 boxes, the user or player may win a payout of 100:1. In addition, the payout may increase for each successive or additional intermediate or final outcome that the user or player's boxes 328 match. For example, the chance of matching a box in two or more intermediate and/or final outcomes in the same game or matching the same box in more than one intermediate and/or final outcome increase exponentially, and the payout would increase correspondingly. The payout for matching the final outcome may also be higher than the payout for matching an intermediate outcome. Likewise, in the example of a sports event, the payout for matching the halftime outcome may be higher than the payout for matching the first or third quarter outcome. Alternatively, the payout for each matched box 328 may be determined based on the separate odds for each intermediate or final outcome with no consideration to the odds of matching more than one box 328.

As another example, each successive match may allow the user or player to win a higher tier of prize or reward. For example, matching a single intermediate or final outcome may provide the user with a tier one prize, e.g., a free item from the concession stand, a free drink, a minor souvenir, a gift card or other similar prizes. As another example, if system 10 determines that only a single match has occurred in step S420 but determines that the match is not for the final outcome in step S422, a tier one prize may be awarded in step S424. Alternatively, if the single match is determined to be for the final outcome in step S422, a tier two prize may be awarded in step S426. The tier two prize may be similar to the tier one prize but have a greater value.

If it is determined that there are two winning boxes in step S420 but not three winning boxes in step S428, the user or player may be awarded a tier three prize in step S430. A tier three prize may be substantially greater than a tier two prize including, for example, more expensive souvenir or team memorabilia, jerseys, tickets to another event at the venue, airline tickets or vouchers, or other similar prizes.

If it is determined that there are three winning boxes in step S428 but not four winning boxes in step S432, the user or player may be awarded a tier four prize in step S434. A tier four prize may be substantially greater than a tier three prize including, for example, a new car, vacation getaway, or other similar prizes.

If it is determined that there are four winning boxes in step S432, e.g., a winning box in each of the intermediate and final outcomes, the user or player may be awarded a jackpot prize in step S436. The jackpot prize may be substantially greater than a tier four prize and may be similar to winning the lottery. For example, the winner of a jackpot prize may receive one million dollars, money for life, or other similar prizes.

The event server 200 may the store prize information and winning criteria for each prize or payout in memory 204. When event server 200 determines that a user or player is a winner, event server 200 may compare the winning boxes 328 to the winning criteria stored in memory 204 to determine the prize and/or payout that the user or player will receive and may transmit to the user device 100 an indication or statement of the awarded prize. For example, event server 200 may credit a user or player's account with a payout, points, or other similar prizes and transmit a notification of the same to user device 100 for presentation to the user or player. If event server 200 determines that the user or player has won a prize, event server 200 may transmit a notification to user device 100 including instructions on how to receive the prize, for example, contact information for guest services or a pickup location.

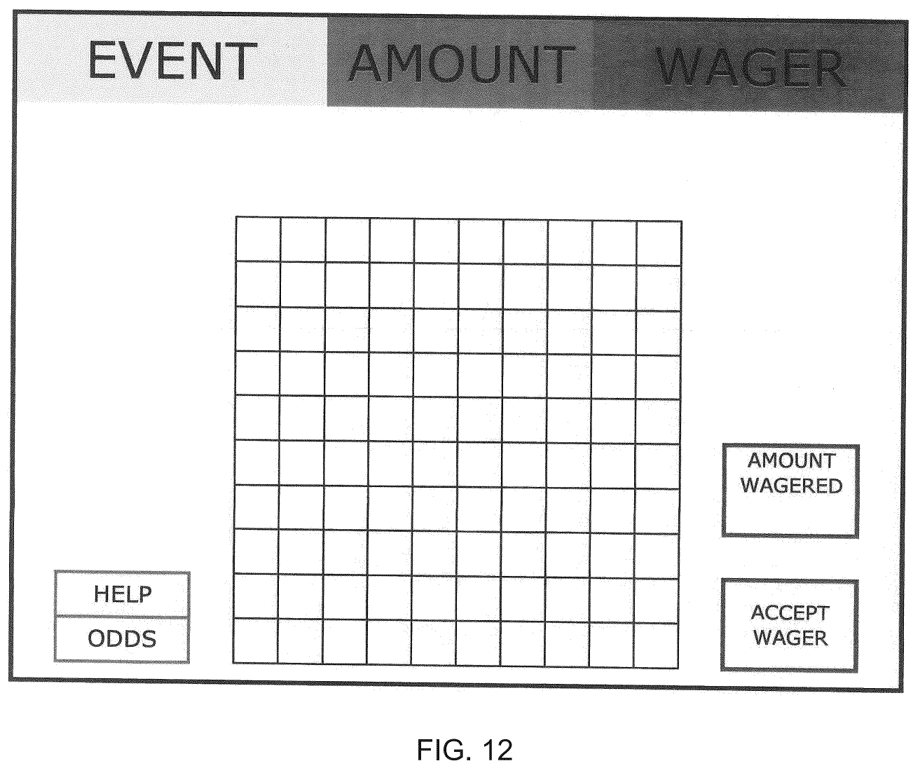

FIGS. 12-19 depict exemplary betting matrices and interface views according to various embodiments. The interfaces may be displayed to users via user devices. The server and/or user device may cause information on the interface to be displayed, e.g., to a user. As shown in these figures, various information may be displayed to users. The user may interact with the interface, e.g., by selecting various indicia displayed in the interfaces, selecting one or more elements in a matrix, and otherwise inputting information. The user may input information to configure and submit a wager as described herein.

As shown in FIG. 12, selectable tabs for Event, Amount, and Wager may trigger different displays, e.g., showing information about the Event, Amount (of the wager), and Wager. A user may select buttons for help, odds, amount wagered, and accept wager, e.g., in order to request and obtain help information, odds information, to enter or obtain information about one or more amounts wagered, to accept a wager, and/or to obtain information about accepted wagers.

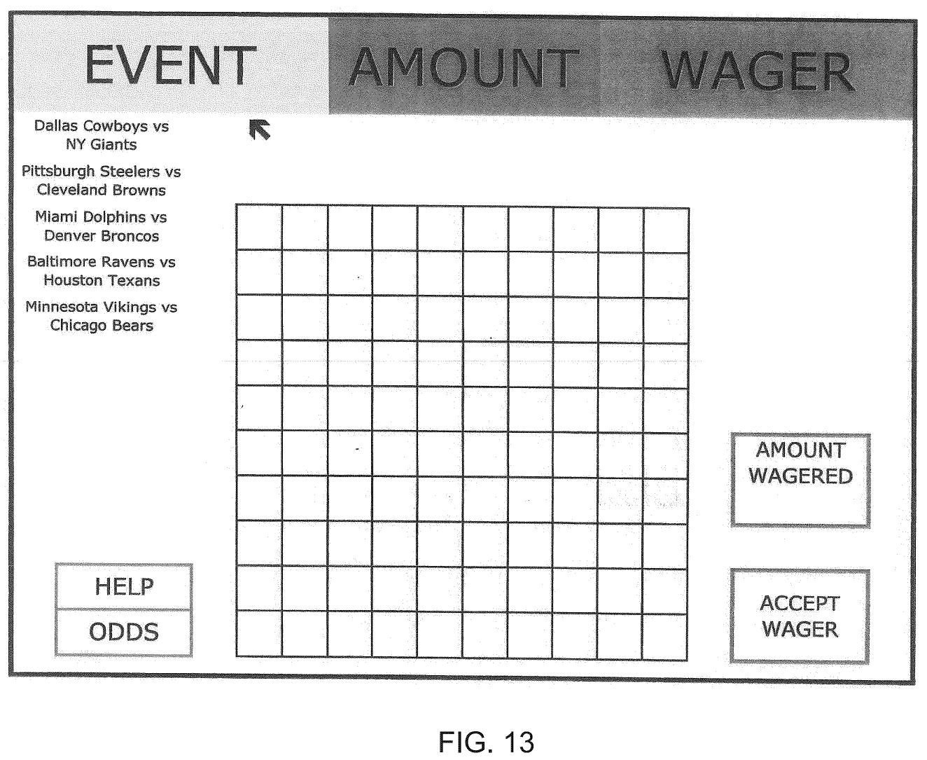

As shown in FIG. 13, a selection of an Event tab in the upper left of the interface may cause the interface to display a plurality of events. The events may comprise events on which wagers may be made, e.g., by the user. For example, the user may select “Dallas Cowboys vs NY Giants” to wager on this game. It should be appreciated that a user may enter one or more bets on one or more events with one or more events and one or more wager resolution times.

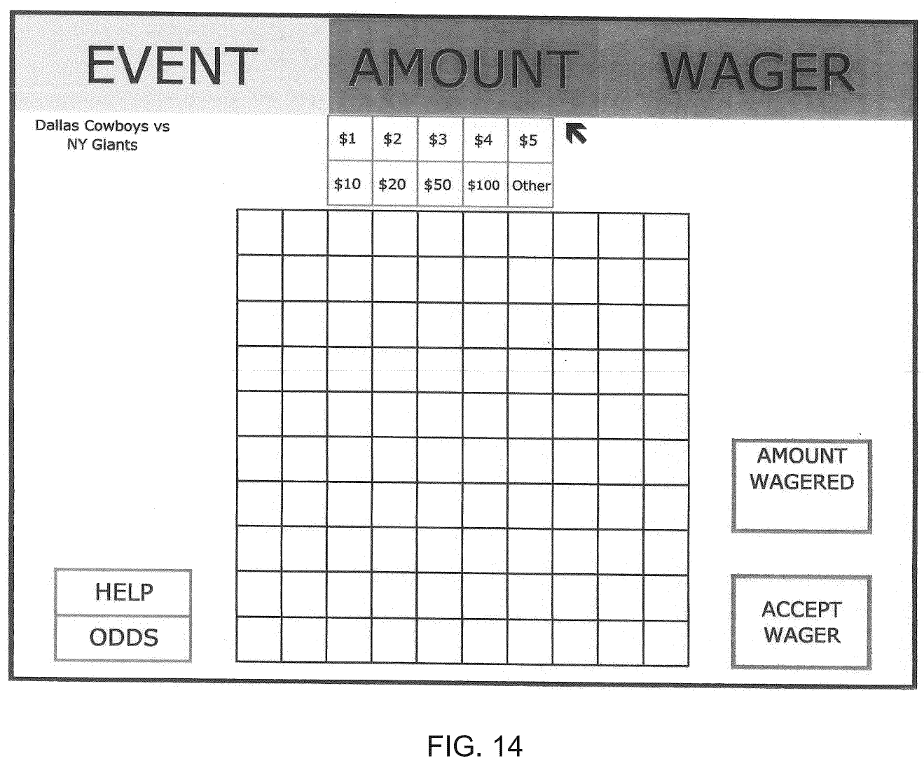

As shown in FIG. 14, a selection of the Amount tab in the upper middle of the interface may cause the interface to display information about wager amounts, e.g., a plurality of selectable wager amounts such as $1, $2, $10, and other amounts. For example, a user may select the $5 icon to select the amount of $5 to apply to the user's wager. In some embodiments, amounts may be manually entered, e.g., via keyboard text.

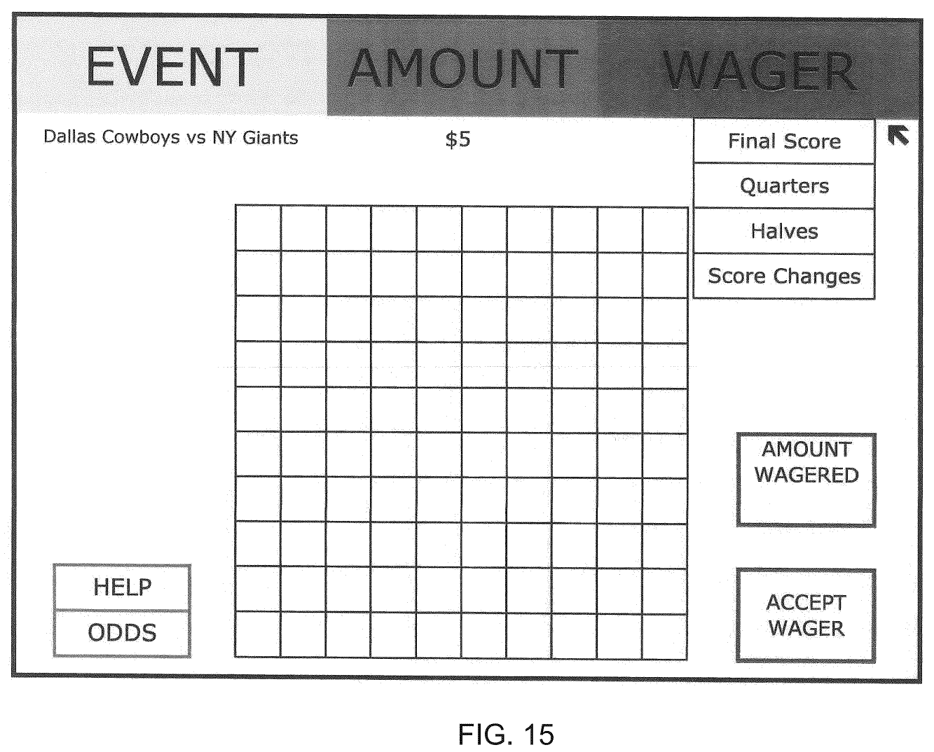

As shown in FIG. 15, a selection of the Wager tab in the upper right may cause the interface to display information about possible points in time (e.g., game periods) that may apply to the wager. For example, for a bet on a score (or other outcome or parameter), selecting “quarters” may configure the bet to be a bet on a score (or other outcome or parameter) as measured at the end of the first (e.g., or second or third) quarter. A selection of “score changes” may configure the bet to be a bet on a score as measured at a score change (e.g., the next score change after the bet is entered, all of the score changes over a period of time such as the first quarter, all of the score changes during a time or game time range, all score changes during the game). It should be appreciated that a single bet may apply to multiple different times; for example, a bet may win provided that a betting selection (e.g., a score corresponding to a bet selection) corresponds to an outcome that occurs at any of a plurality of times. For example, in some embodiments, a bet that the last digit of a first team's score will be “8” and the last digit of a second team's score will be “3” may be a winning bet provided that the these conditions are true (1) at the end of the first period, at the end of the second period, at the end of the third period, and/or at the end of the fourth period, e.g., if the “Quarters” button is selected for that bet. Similarly, in some embodiments, the bet corresponding to “Score Changes” may be a winning bet if both of (or one of) the selected conditions are true at any score change throughout the game. In some embodiments, the Wager Tab being initiated may trigger the display of the possible wagers that are available for the event selected.

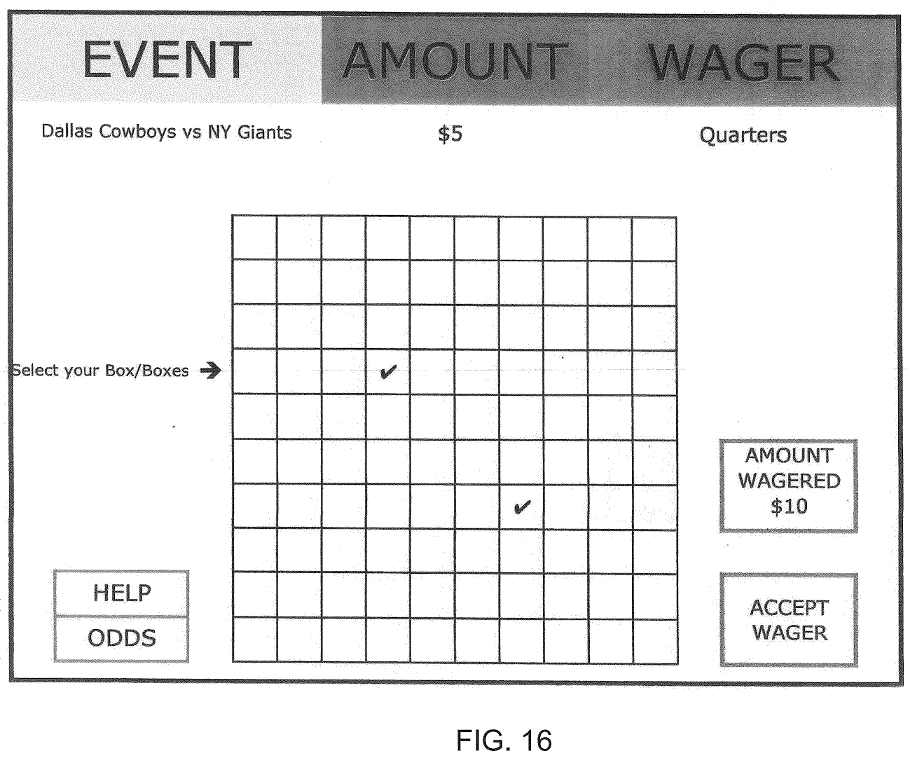

FIG. 16 illustrates, e.g., an initiation of selecting the boxes by the player. The Event, Amount, and Wager type may already have been selected and may be displayed. In this example, the player selected two boxes in the betting grid and the amount of the total wager is displayed in the Amount Wagered Box (e.g., $10).

As shown in FIG. 16, one or more boxes in the bet matrix may be selected, e.g., by a user clicking inside a selected box. The interface may indicate the selected boxes, e.g., with a check mark. In some embodiments, different betting amounts and other conditions (e.g., quarters, times, etc.) may be entered for each selection on a single matrix. In other embodiments, a set of selections (e.g., wager amount, time, etc.) may apply to all selections on one or more matrices. As shown in FIG. 16, an Amount Wagered box may show a total amount wagered, e.g., $10 of total wagers including a $5 wager on the first selection and $5 on the second selection. In some embodiments, the bet may be entered and confirmed upon clicking the “accept wager” button, e.g., at the interface of FIG. 16.

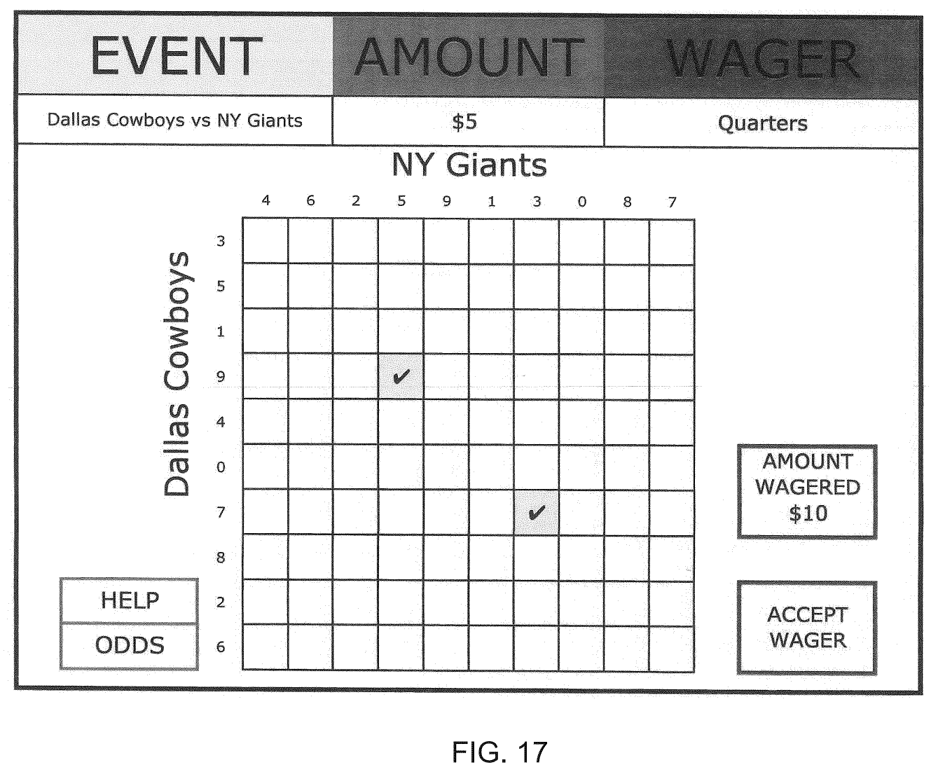

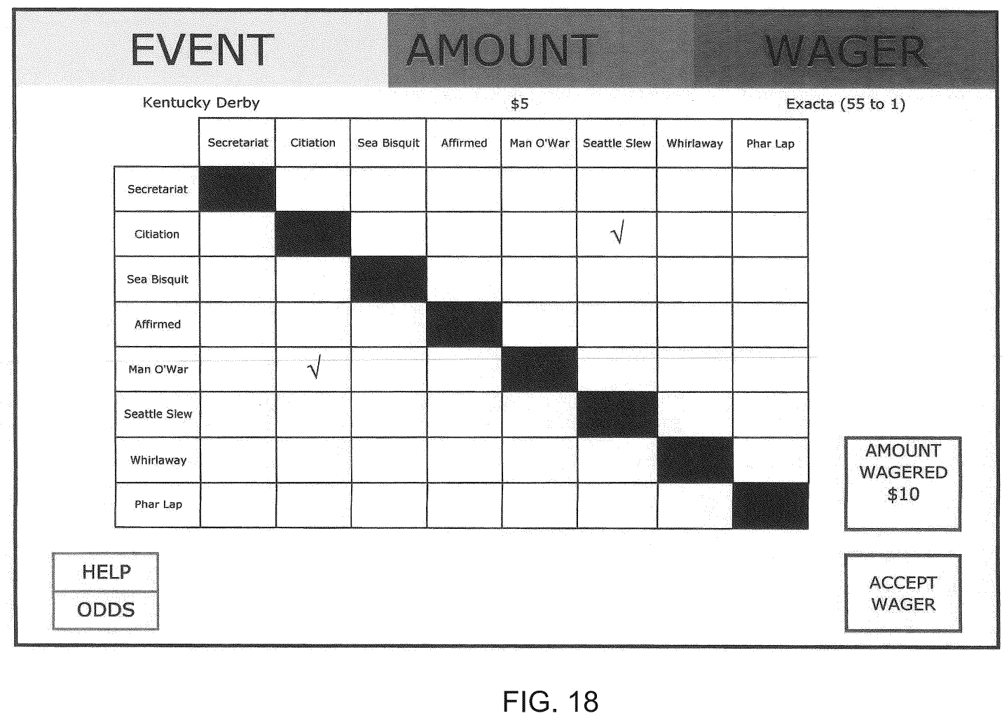

As shown in FIG. 17, information about the specific possible outcomes corresponding to each row and column may be displayed to the user, e.g., after (or before) the user has selected specific boxes in the matrix. For example, FIG. 17 shows that the first row corresponds to a “3” being the last digit of a Dallas Cowboys score (e.g., at the end of a quarter), and FIG. 17 shows that the first column corresponds to a “4” being the last digit of a NY Giants score (e.g., at the end of a quarter). The upper left selection box may correspond to a Giants last digit of 5 and a Cowboys last digit of 9. The lower right selection may correspond to a Giants last digit of 3 and a Cowboys last digit of 7.

For example, FIG. 17 may show the wagering screen after all selections have been made, the teams have been placed on their respective axis 100, and the numbers have been selected for each row and column. In this example, the player may have placed two $5 wagers on a football contest between the Dallas Cowboys and the New York Giants where an outcome will be produced at the end of each quarter. The total wager is $10 and the player will win if at the end of any quarter, the single digit representing the score for the Dallas Cowboys is 9 and the single digit representing the score for the New York Giants is 5 (e.g., Cowboys 29 and Giants 35 may trigger a win on this bet) for the first box or the single digit representing the score for the Dallas Cowboys is 7 and the single digit representing the score for the New York Giants is 3 (e.g., Cowboys 17 and Giants 23 may trigger a win on this bet) for the second box.

It should be appreciated that while each box selection will correspond to a set of specific outcomes, those specific outcomes may not be determined and/or revealed to the user until after the user submits the bet(s) and/or the bet(s) are accepted by the system. In other embodiments, such specific outcomes (e.g., the specific possible outcomes corresponding to each row and column) may be communicated to the user before the user makes some or all of the user's bets.

Also, in some embodiments, information identifying the types or categories of outcomes for the rows and columns may be provided before (or after) the user makes selections in the matrix. For example, before or after user selection, the interface may identify that the rows will represent different possible Dallas Cowboys scores, and the columns will represent different possible NY Giants scores. This information may or may not be provided at the same time as specific values or outcomes for those categories.

FIG. 18 depicts an exemplary interface for a horse race such as the Kentucky Derby. This interface may correspond to two exacta bets made at $5 each (for a total of $10 wagered). The upper right selection may comprise a $5 exacta bet that Seattle Slew will come in first and Citation will come in second (or, depending on the whether rows or columns indicate the first place horse, the bet may comprise a bet that Citation will come in first and Seattle Slew will come in second place). Similarly, the lower left selection may comprise a $5 bet that Citation will come in first and Man O'War in second (or that Man O'War will come in first and Citation in second). Information about the odds of one or more of the bets may be displayed in the upper right. For example, the odds of one of the bets may be shown, or net odds for multiple bets.

In some embodiments, an interface similar to that of FIG. 18 may apply to quinella bets, where both the rows and columns apply to a horse coming in either first or second. Accordingly, if the bets of FIG. 18 were quinella bets, then the upper right bet would comprise a bet that (1) Seattle Slew will come in either first or second and (2) Citation will also come in either first or second.

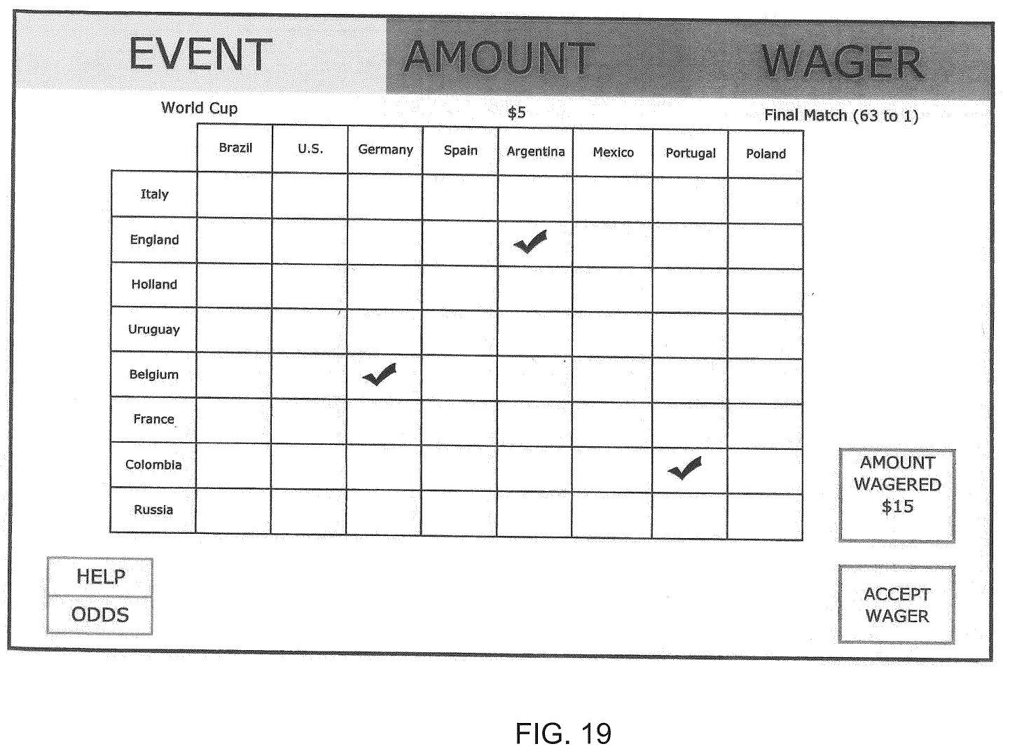

FIG. 19 depicts an exemplary interface for betting, e.g., on a final matchup of a multi-stage event such as the World Cup. For example, the interface of FIG. 19 may illustrate three different $5 bets (for a total of $15 wagered) on potential matchups in the finals of the World Cup. For example, the bottom right bet may comprise a $5 bet that Portugal and Colombia will both reach the finals of the World Cup. Odds about each bet (or the combination of bets) may be displayed, e.g., in the upper right.

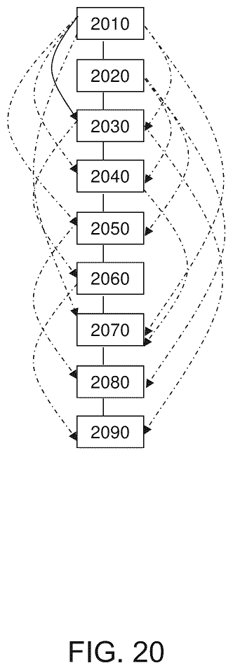

FIG. 20 depicts an exemplary flow chart according to various embodiments.

In block 2010, a user may request information about making a wager.

In block 2020, information about wagerable events may be provided to the user. For example, a list of wagerable events may be provided to the user.

In block 2030, the user may select a wagerable event. One or more betting matrices may be displayed to the user. The user may select one or more boxes of each matrix. Information about odds corresponding to each selection (or a combination of selections) may be displayed (e.g., or in some embodiments may be displayed at a later time, e.g., after the user has made the wager).

In block 2040, the user may select wager information such as a wager amount corresponding to each selection and a wager timeframe corresponding to each selection (e.g., quarters, final score, time range, score change, etc.). The user may (or may not) have information (e.g., displayed) about the categories and/or values corresponding to each row and column of each matrix.

In block 2050, the user may submit one or more bets corresponding to the user's selected element(s) of the one or more betting matrices (e.g., matrices corresponding to one or more events and/or one or more bet types for a single event). The bet(s) may be confirmed by the system, e.g., regardless of whether anyone else bets on any of the same betting events or bet matrices.

In some embodiments, two different users may make the same bet via the same betting matrix (or two iterations of the same betting matrix) by selecting the same box location on the betting matrix, wherein the same outcome values are assigned to the same rows and columns of both matrices.

In block 2060, one or more other users may place one or more bets on one or more of the same betting events. The users may use the same matrices on the same interface (e.g., using a different login ID), or on a corresponding identical matrix at a different interface on a different user device.

In some embodiments, different matrices may be generated for different users (e.g., a matrix whose row and column values are different from the first user's matrix, or that have the same values but in a different order compared to the first user's matrix). It should be appreciated that when the matrices do not show row and column values, different matrices may look identical even though their rows and columns will not match one another later.

In block 2070, possible outcome information may be displayed. (This may occur earlier in this process, e.g., before the user's bet(s) are confirmed.) For example, each bet selection in a matrix may correspond to an outcome associated with the relevant row and an outcome associated with a relevant column. The selected outcomes may be displayed to the user, e.g., before (and/or after) the bet(s) are confirmed.

In some embodiments, users may configure and place more bets after the matrix row and column values are displayed.

In block 2080, event information may be monitored to determine whether any selected betting outcome is a winning outcome. In some embodiments, a row may be resolved at a different time as a column, e.g., if the row corresponds to a score at the end of the first quarter and the column corresponds to a score at the end of a half, or if the row corresponds to a potential winner of a Best Actress Category and the column corresponds to a potential winner of a Best Director category, e.g., at the Academy Awards. In some embodiments, a bet may be resolved over a time period, e.g., if the bet concerns score digits that ever occur during a game. In some embodiments, cumulative wins may be triggered each time the selected bet conditions (e.g., last digits of Cowboys 2 and Giants 3) occur during the game, e.g., if the selected digits occur more than once during a game. In other embodiments, a win may only be triggered once regardless of the number of times those digits hit. In some embodiments, the bet may win and clear out once the bet is won, e.g., and the user may submit another bet. In some embodiments, the user may continue to submit additional bets on the competition throughout the competition.

In some embodiments, a bet may comprise a combination bet of multiple selections (e.g., on one matrix or multiple different matrices) wherein the combination bet does not win unless all of the selected conditions of all matrix selections are satisfied. In other embodiments, a combination bet may be a winning bet provided that any of the selected bets is a winning bet.

In block 2090, one or more payouts may be paid, e.g., on any winning bets.

In some embodiments, a selection of a matrix may apply to a plurality of different bets over time. For example, a selection of a box in the third row, second column may be applied to a basketball game, and then applied to a football game, and then applied to two completely different bet types concerning a tennis match. In this way, the user may only have to select one box to apply to a wide range of bets. Each bet may have a different set of possibilities assigned to the rows and columns. In some embodiments, the user may still configure information about the bet (such as amount, timing, etc.). In other embodiments, defaults may be assigned to one or more bets of the user.

In some embodiments, a user may pay once for single box (e.g., $5), and the bet may apply to multiple games (with different values (e.g., random values) assigned to the rows and columns for each bet). In some embodiments, the bet may (1) win if any one game wins; (2) win only if all games win; (3) win if games 1 and 3 (or other combination) win for the selected box.

It should be appreciated that the systems and methods described herein may be adapted to a variety of different sports, games, competitions, tournaments, series, and other events. Various embodiments are described for head to head scoring games (e.g., basketball or football), wherein ten rows represent ten possible last digits of a score for one competitor and ten columns represent ten possible last digits of a score for another competitor. It should be appreciated that while the rows and columns may comprise the digits 0-9, in other embodiments the rows and columns may also comprise only some of the digits (e.g., 0, 5, and 7), or in other embodiments the rows and columns may refer to full team scores (e.g., 3, 6, 7, 9, 10, 14, 17, 21, etc.) rather than final digits of the team score. In other embodiments, other parameters besides scores may be used, e.g., as described herein.

It should be appreciated that a rectangular bet matrix of rows and columns is described for exemplary purposes. In some embodiments, the matrix need not be rectangular, and in some embodiments the “bet matrix” need not be arranged in rows and columns. Any system that can pair one or more elements from one set (e.g., the “row” elements) with one or more element from another set (e.g., the “column” elements) may be contemplated.

Events for which final or intermediate outcomes may be the subject of a one or more bets described herein may comprise: tennis, basketball, football, Australian football, soccer, hockey, baseball, softball, kickball, lacrosse, rugby, cricket, racquetball, badminton, table tennis, squash, jai alai, volleyball, wallyball, curling, swimming, gymnastics, track and field, polo, water polo, equestrian sport, ultimate frisbee, racing, skateboarding, mountaineering, boxing, wrestling, kickboxing, mixed martial arts, billiards, 9-ball, water sports, skating, sledding, snow or water skiing, snowboarding, a board game, chess, checkers, poker, blackjack, roulette, craps, dice game, casino game, lottery, card game, video game, backgammon, baccarat, snow sports, and other competitions. Various embodiments described herein may be applied to two-party scoring contests wherein each party can score throughout the game, and the party with the highest score at the end of the game wins.

Other events may comprise TV competitions, elections, competitions decided by a vote or other criteria, competitions involving a plurality of competitors wherein competitors are eliminated (e.g., voted off) over time. Generally speaking, any event or set of events having at least two potential outcomes may be considered.

For example, various embodiments herein may be applied to American Idol, America's Got Talent, The Voice, X Factor, Top Chef, The Next Iron Chef, Survivor, Big Brother, The Amazing Race, Fear Factor, The Apprentice, The Biggest Loser, Wipeout, America's Next Top Model, Dancing With the Stars, Miss America, Miss USA, the Academy Awards, the Golden Globes, the Emmy Awards, the Tony Awards, People's Choice awards, the Grammy's, and other competitions.

Various embodiments may be used for appointments or elections, e.g., political elections for senate, house, president, and/or other positions. For example, a betting matrix may show a number of senator candidates across top (e.g., 10 candidates) and a margin of winning across the side, or a number of candidates across the top and a number of candidates across the side. In some embodiments, 10 senator candidates in different states may correspond to the columns and be shown across top (wherein all might win, and all might lose). The left side may correspond to (a) another ten senators, or (b) representative candidates, or (c) a margin of winning. In some embodiments, a number of different boxes in the matrix would be winning boxes. In some embodiments, a matrix may have no winning boxes. In some embodiments, a winning box would still require a winning row and winning column happening together.

In some embodiments, the rows may apply to a plurality of contestants, and the columns may apply to the same or different plurality of contestants. For example, the bet may comprise a bet that the selected row and column contestants will reach the finals (e.g., of March Madness), or that the row contestant will win, and the column contestant will come in second (or vice versa, or either). For example, for a bet on a March Madness finals matchup in college basketball, the Sweet Sixteen teams may correspond to the rows, and the Sweet Sixteen teams may correspond to the columns, wherein a selected box corresponds to a specific row team and a specific column team. (It should be appreciated that the matrix and betting may be configured so that a user cannot select the same team in both the row and column, e.g., by using the same order for the rows and columns and blocking out the diagonal, e.g., as shown in FIG. 18.) In some embodiments, the bet may pay out some money if either of the two teams reach the finals. In some embodiments, a payout on a final's matchup bet may pay a bonus under certain circumstances, e.g., if a specific side, e.g., the “row” team, wins the finals.

In some embodiments, a single matrix selection may be associated with 1, 2, 3, or 4 outcomes (e.g., corresponding to possible outcomes and outcome types that may be listed at the top side, left side, right side, and bottom of the matrix). Different payouts may be paid depending on whether 1, 2, 3, or 4 of the selected possible outcomes occur. For example, greater odds and payouts may be provided for hitting all four outcomes.

For example, the top, bottom, left, and right sides of the matrix may correspond to a last digit of a first team at the end of the first quarter, a last digit of a second team at the end of the first quarter, a last digit of a first team at the end of the game, and a last digit of a second team at the end of the game. The different sides may also correspond to different events (e.g., a basketball game, football game, and tennis match, or multiple football games), different bet types, and different bet resolution times.

In some embodiments, a row or column of a matrix may correspond to outcomes such as possible rolls of dice, e.g., in a craps game. The relevant row (e.g., in combination or not in combination with a selected column outcome) may pay each time the selected number is rolled (e.g., “6”). In some embodiments, rules may specify that the bet pays each time the relevant number is rolled (e.g., “6”) until one or more other numbers are rolled (e.g., numbers that do not correspond to a row), such as 7, in which case the bet becomes cancelled. Accordingly, the user may hope that a 6 is rolled many times before a 7 is rolled to maximize the user's payout.

In another exemplary embodiment, one side (such as the columns) may represent two competitors in a competition, such as two boxers in a boxing match. The other side (such as the rows) may correspond to a number of rounds. A bet may be a winning bet if it corresponds to the winning competitor and the corresponding round in which the boxing match ended. In some embodiments, a side (such as the top side) may further specify further possible outcome information, such as the type of win (e.g., knock-out or technical knock-out). For example, four columns may eventually be labeled Boxer 1 KO, Boxer 1 TKO, Boxer 2 KO, Boxer 2 TKO.

It should be appreciated that while the present application mentions boxes of a two-dimensional rectangular matrix and two-dimensional coordinate pairs as examples, any construct may be used that is capable of specifying an element from a first set together with an element of a second set. In other embodiments involving more than two sets, elements may correspond to elements of three (or more) different sets, and may be designated using, e.g., a three dimensional rectangular prism or three-dimensional coordinates (3, 4, 5), or tensors or 4+ dimensional coordinates for four or more sets. Thus, coordinates in three dimensions such as (3, 4, 5) may refer to the third element of a first set, a fourth element of a second set, and a fifth element of a third set.

In some embodiments, a user may select one or more elements (e.g., specific boxes in a box matrix or coordinate pairs) before specific values of those elements are displayed to or otherwise received by the user. For example, the user may select one or more boxes in a blank grid without knowing what values the selected boxes correspond to. In some embodiments, information about the values may be displayed or output to (or otherwise communicated to) a user before the user selects any element or box.

The following are exemplary embodiments:

A1. A method comprising:
receiving, by at least one processor of at least one computer, from a first user a request to submit a wager;
responsive to the request to submit a wager, causing to be communicated to the first user, by the at least one processor, a first betting matrix comprising a plurality of selectable elements arranged in rows and columns;
receiving, by the at least one processor, from the first user a first bet comprising a selection by the first user of a first one of the plurality of selectable elements, the first selected element being in a selected one of the rows and in a selected one of the columns;
responsive to receiving the first bet from the first user, causing to be communicated to the first user, by the at least one processor, a confirmation that the first bet is in effect, wherein a payout will be paid on the first bet if the first bet is a winning bet;
causing to be communicated to the first user, by the at least one processor, betting category information associated with the first betting matrix, the betting category information comprising a first category of possible outcomes corresponding to the rows and a second category of possible outcomes corresponding to the columns;
causing to be communicated to the first user, by the at least one processor, possible outcome indicia indicating a plurality of possible outcomes associated with the rows and columns of the first betting matrix, the possible outcome indicia comprising (1) for each row, indicia indicating a respective possible outcome of the first category corresponding to said row and (2) for each column, indicia indicating a respective possible outcome of the second category corresponding to said column, in which the first selected element corresponds to both (a) the respective possible outcome of the first category corresponding to the selected row and (b) the respective possible outcome of the second category corresponding to the selected column;
determining, by the at least one processor, a first actual outcome corresponding to at least one of the possible outcomes of the first category and a second actual outcome corresponding to at least one of the possible outcomes of the second category; and
responsive to determining a first actual outcome and a second actual outcome, cause to be communicated to the first user, by the at least one processor, information indicating whether the first bet is a winning bet.

A2. The method of embodiment A1 (and/or any other mutually consistent embodiments above), further comprising:
in which the act of determining a first actual outcome and a second actual outcome comprises determining that (1) the possible outcome corresponding to the selected row actually occurred and (2) the possible outcome corresponding to the selected column actually occurred;
in which the act of causing to be communicated information indicating whether the first bet is a winning bet comprises causing to be output to the user indicia indicating that the first bet is a winning bet; and
responsive to determining that determining that (1) the possible outcome corresponding to the selected row actually occurred and (2) the possible outcome corresponding to the selected column actually occurred, causing a payout to be paid to the first user.

A3. The method of embodiment A1 (and/or any other mutually consistent embodiments above), in which the act of causing to be communicated to the first user betting category information comprises causing to be displayed to the first user:
indicia indicating the first category adjacent to a left side of the first betting matrix indicia; and
indicia indicating the second category adjacent to a top side of the first betting matrix indicia.

A4. The method of embodiment A1 (and/or any other mutually consistent embodiments above), in which the betting category information further comprises a third category of possible outcomes corresponding to a side comprising one of (1) a right side corresponding to the rows and (2) a bottom side corresponding to the columns,
in which the possible outcome indicia further comprises, for each of the rows or columns of the side, indicia indicating a respective possible outcome of the third category corresponding to said row or column, in which the first selected element further corresponds to the respective possible outcome of the third category corresponding to the selected row or column of the side, and
in which the act of causing to be communicated to the first user betting category information comprises causing to be displayed to the first user:
indicia indicating the first category adjacent to a top side of indicia indicating the first betting matrix;
indicia indicating the second category is displayed adjacent to a left side of the indicia indicating the first betting matrix;
indicia indicating the third category is displayed adjacent to a bottom or right side of the indicia indicating the first betting matrix; and

A5. The method of embodiment A4 (and/or any other mutually consistent embodiments above), further comprising determining whether the first bet is a winning bet, in which the first bet is determined to be a winning bet only if (1) the possible outcome of the first category corresponding to the selected row actually occurs, (2) the possible outcome of the second category corresponding to the selected column actually occurs, and (3) the possible outcome of the third category corresponding to the selected row or column of the side actually occurs.

A6. The method of embodiment A1 (and/or any other mutually consistent embodiments above), in which the betting category information further comprises a third category of possible outcomes corresponding to the rows and a fourth category of possible outcomes corresponding to the columns, and
in which the possible outcome indicia further comprises (1) for each row, indicia indicating a respective possible outcome of the third category corresponding to said row and (2) for each column, indicia indicating a respective possible outcome of the fourth category corresponding to said column, in which the first selected element further corresponds to both (a) the respective possible outcome of the third category corresponding to the selected row and (b) the specific possible outcome of the fourth category corresponding to the selected column.

A7. The apparatus of embodiment A6 (and/or any other mutually consistent embodiments above), in which the act of causing to be communicated to the first user betting category information comprises causing to be displayed to the first user:
indicia indicating the first category adjacent to a top side of indicia indicating the first betting matrix;
indicia indicating the second category is displayed adjacent to a left side of the indicia indicating the first betting matrix;
indicia indicating the third category is displayed adjacent to a bottom side of the indicia indicating the first betting matrix; and
indicia indicating the fourth category is displayed adjacent to a right side of the indicia indicating the first betting matrix.

A8. The method of embodiment A7, in which the first bet is determined to be a winning bet only if (1) the possible outcome of the first category corresponding to the selected row actually occurs, (2) the possible outcome of the second category corresponding to the selected column actually occurs, (3) the possible outcome of the third category corresponding to the selected row actually occurs, and (4) the possible outcome of the fourth category corresponding to the selected column actually occurs.

A9. The method of embodiment A7 (and/or any other mutually consistent embodiments above), in which the first bet cannot be a winning bet unless at least one of the following conditions is satisfied:
(1) the possible outcome of the first category corresponding to the selected row and the possible outcome of the second category corresponding to the selected column both actually occur; and
(2) the possible outcome of the third category corresponding to the specific row and the possible outcome of the fourth category corresponding to the specific column both actually occur.

A10. The method of embodiment A7 (and/or any other mutually consistent embodiments above), in which the first bet is a winning bet if at least one of the following conditions is satisfied:
(1) the possible outcome of the first category corresponding to the selected row and the possible outcome of the second category corresponding to the selected column both actually occur;
(2) the possible outcome of the third category corresponding to the specific row and the possible outcome of the fourth category corresponding to the specific row both actually occur;
(3) the possible outcome of the first category corresponding to the selected row and the possible outcome of the fourth category corresponding to the selected column both actually occur; and
(4) the possible outcome of the third category corresponding to the specific row and the possible outcome of the second category corresponding to the specific column both actually occur.

A11. The method of embodiment A1 (and/or any other mutually consistent embodiments above),
in which the first bet further comprises a selection by the first user of a second one of the plurality of selectable elements, the second selected element being in a specific one of the rows and in a specific one of the columns, the second selected element being different from the first selected element and being in at least one of a different row and a different column compared to the first selected element, and
in which the second selected element corresponds to both (a) the respective possible outcome of the first category corresponding to the specific row and (b) the specific possible outcome of the second category corresponding to the specific column.

A12. The method of embodiment A11 (and/or any other mutually consistent embodiments above), further comprising determining whether the first bet is a winning bet, in which the first bet cannot be winning bet unless (1) the possible outcome corresponding to the selected row actually occurs, (2) the possible outcome corresponding to the selected column actually occurs, (3) the possible outcome of the first category corresponding to the specific row of the second selected element actually occurs, and (4) the possible outcome of the second category corresponding to the specific column of the second selected element actually occurs.

A13. The method of embodiment A11 (and/or any other mutually consistent embodiments above), further comprising determining whether the first bet is a winning bet, in which the first bet is determined to be a winning bet if at least one of the following conditions is satisfied:
(1) the possible outcome corresponding to the selected row and the possible outcome corresponding to the selected column both actually occur, and
(2) the possible outcome of the first category corresponding to the specific row of the second selected element and the possible outcome of the second category corresponding to the specific row of the second selected element both actually occur.

A14. The method of embodiment A1 (and/or any other mutually consistent embodiments above), in which the information defining the elements in the first betting matrix is communicated to the first user after the first selected element is selected by the first user but before the second selected element is selected by the first user.

A15. The method of embodiment A1 (and/or any other mutually consistent embodiments above), in which the request to submit a wager comprises a request to submit a wager relating to an event comprising a head-to-head competition between a first entity and a second entity, and in which each row of the first betting matrix corresponds to a specific possible performance outcome of the first entity and each column of the first betting matrix corresponds to a specific possible performance outcome of the second entity.

A16. The method of embodiment A1 (and/or any other mutually consistent embodiments above),
in which the request to submit a wager comprises a request to submit a wager relating to an event comprising a competition involving at least two entities, the at least two entities comprising a first entity and a second entity,
in which the competition comprises at least one of tennis, basketball, football, Australian football, soccer, hockey, baseball, softball, kickball, lacrosse, rugby, cricket, racquetball, badminton, table tennis, squash, jai alai, volleyball, wallyball, curling, a swimming competition, a gymnastics competition, a track and field competition, polo, water polo, an equestrian sport, ultimate frisbee, racing, skateboarding, mountaineering, boxing, wrestling, kickboxing, mixed martial arts, billiards, 9-ball, a water sport, a skating competition, a sledding competition, a skiing competition, chess, checkers, a board game, a card game, a video game, backgammon, baccarat, and a snow sport.

A17. The method of embodiment A16 (and/or any other mutually consistent embodiments above), in which each row of the first betting matrix corresponds to a specific possible performance outcome of the first entity and each column of the first betting matrix corresponds to a specific possible performance outcome of the second entity, and

A18. The method of embodiment A1 (and/or any other mutually consistent embodiments above), in which:
the first bet concerns at least one competition;
the first category is associated with at least one first specific placement in the at least one competition at a first defined point in the at least one competition;
the second category is associated with at least one second specific placement in the at least one competition at a second defined point in the at least one competition in which the second defined point in the at least one competition is one of (a) the same as and (b) different from the first defined point in the at least one competition;
the possible outcomes corresponding to each row comprise a plurality of participants who may achieve the at least one first specific placement at the first defined point in the at least one competition;
the possible outcomes corresponding to each column comprise a plurality of participants who may achieve the at least one second specific placement at the second defined point in the competition; and
in which the first bet cannot be winning bet unless (1) the participant corresponding to the selected row achieves the at least one first specific placement at the first defined point in the at least one competition and (2) the participant corresponding to the selected column actually achieves the at least one second specific placement at the second defined point in the competition.

A19. The method of embodiment A18 (and/or any other mutually consistent embodiments above), in which:
the at least one competition is selected from the group consisting of: a single game, a tournament, a multi-round elimination game, a round robin, a pre-season, a regular season, and a playoffs;
at least one of the first defined point and the second defined point comprises a conclusion of the at least one event; and
at least one of the first specific placement and the second specific placement comprises one of: a finishing position, a ranking, a win or loss status, a number of points, and a score.

A20. The method of embodiment A19 (and/or any other mutually consistent embodiments above), in which:
at least one of the first defined point and the second defined point comprises a time before the conclusion of the at least one event.

A21. The method of embodiment A19 (and/or any other mutually consistent embodiments above), further comprising determining if the first bet is a winning bet, wherein the first bet is a winning bet if one of the following two conditions is satisfied:
(1) the at least one first specific placement is first place in the at least one competition and the at least one second specific placement is second place in the at least one competition; or
(2) the at least one first specific placement is second place in the at least one competition and the at least one second specific placement is first place in the at least one competition.

A22. The method of embodiment A21 (and/or any other mutually consistent embodiments above), in which the at least one competition consists of a single competition among at least three participants

A23. The method of embodiment A22, in which the at least one competition comprises one of a horse race and an automobile race.

A24. The method of embodiment A19 (and/or any other mutually consistent embodiments above), in which:
the at least one first specific placement comprises at least one of first place and second place; and
the at least one second specific placement comprises at least one of first place and second place;
the first bet is a winning bet if (1) the participant corresponding to the selected row achieves first or second place and (2) the participant corresponding to the selected column actually achieves first or second place.

A25. The method of embodiment A24 (and/or any other mutually consistent embodiments above), in which the at least one competition is selected from the group consisting of a horse race and an automobile race.

A26. The method of embodiment A1 (and/or any other mutually consistent embodiments above), in which:
the first bet concerns at least one competition;
the first category is associated with a first parameter of the at least one competition measured at a first defined point in the at least one competition;
the second category is associated with a second parameter of the at least one competition measured at a second defined point in the at least one competition, in which the second defined point in the at least one competition is one of (a) the same as and (b) different from the first defined point in the at least one competition;
the possible outcomes corresponding to each row comprise a plurality of first parameter values that may occur at the first defined point in the at least one competition;
the possible outcomes corresponding to each column comprise a plurality of second parameter values that may occur at the second defined point in the competition; and
the first bet cannot be winning bet unless (1) the first parameter value corresponding to the selected row occurs at the first defined point in the at least one competition and (2) the second parameter value corresponding to the selected column occurs at the second defined point in the at least one competition.

A27. The method of embodiment A26 (and/or any other mutually consistent embodiments above), in which the first point and the second point of the at least one competition are different such that the first point occurs at a different time than the second point.

A28. The method of embodiment A26 (and/or any other mutually consistent embodiments above), in which the first point and the second point of the at least one competition are the same such that the first point occurs at the same time as the second point.

A29. The method of embodiment A26 (and/or any other mutually consistent embodiments above), in which:
the at least one competition is selected from the group consisting of: a single game or match, a single race, a pre-defined group of races, a tournament, an election, a multi-round competition, one or more rounds of a multi-round competition, a round robin, a pre-season, a regular season, and a playoffs;
at least one of the first parameter and the second parameter comprises a score of a competitor in the at least one competition.

A30. The method of embodiment A26 (and/or any other mutually consistent embodiments above), in which:
at least a first competitor and a second competitor participate in the at least one competition;
the first parameter comprises a score of the first competitor;
the second parameter comprises a score of the second competitor; and
the possible outcomes corresponding to each row comprise a plurality of possible values that may correspond to the first competitor's score as measured at the first defined point;
the possible outcomes corresponding to each column comprise a plurality of possible values that may correspond to the second competitor's score as measured at the second defined point; and
the first bet cannot be a winning bet unless (1) the possible value corresponding to the selected row corresponds to the first competitor's score as measured at the first defined point and (2) the possible value corresponding to the selected column corresponds to the second competitor's score as measured at the second defined point.

A31. The method of embodiment A30 (and/or any other mutually consistent embodiments above), in which at least one of the first defined point and the second defined point comprises a conclusion of the at least one event.

A32. The method of embodiment A31 (and/or any other mutually consistent embodiments above), in which at least one of the first defined point and the second defined point comprises a time before a conclusion of the at least one event.

A33. The method of embodiment A30 (and/or any other mutually consistent embodiments above), in which at least one of the first defined point and the second defined point occurs prior to an end of the at least one competition and comprises one of: an end of a quarter, an end of a half, an end of an inning, and an end of a possession.

A34. The method of embodiment A26 (and/or any other mutually consistent embodiments above), in which:
the possible outcomes corresponding to each row comprise a plurality of possible scores of the first competitor as measured at the first point;
the possible outcomes corresponding to each column comprise a plurality of possible scores of the second competitor as measured at the second point; and
the first bet cannot be a winning bet unless (1) the possible score corresponding to the selected row is the first competitor's score as measured at the first defined point and (2) the possible score corresponding to the selected column is the second competitor's score as measured at the second defined point.

A35. The method of embodiment A26 (and/or any other mutually consistent embodiments above), in which:
the possible outcomes corresponding to each row comprise a plurality of possible ending digits of the first competitor's score as measured at the first point, in which the possible outcomes corresponding to each row comprise one or more of the digits 0, 1, 2, 3, 4, 5, 6, 7, 8, and 9;
the possible outcomes corresponding to each column comprise a plurality of possible ending digits of the second competitor's score as measured at the second point, in which the possible outcomes corresponding to each row comprise one or more of the digits 0, 1, 2, 3, 4, 5, 6, 7, 8, and 9; and
the first bet cannot be a winning bet unless (1) the ending digit corresponding to the selected row corresponds is the ending digit of the first competitor's score as measured at the first defined point and (2) the ending digit corresponding to the selected column is the ending digit of the second competitor's score as measured at the second defined point.

A36. The method of embodiment A26 (and/or any other mutually consistent embodiments above), in which:
the at least one competition is selected from the group consisting of: a single game or match, a single race, a pre-defined group of races, a tournament, an election, a multi-round competition, one or more rounds of a multi-round competition, a round robin, a pre-season, a regular season, and a playoffs;
at least one of the first parameter and the second parameter comprises a score of a competitor in the at least one competition;
at least one of the first defined placement and the second defined placement comprises one of: a finishing position, a ranking, a win or loss status, a number of points, and a score.

A37. The method of embodiment A26 (and/or any other mutually consistent embodiments above), in which at least one of the first defined point and the second defined point comprises a time at which a score changes in the at least one competition.

A38. The method of embodiment A1 (and/or any other mutually consistent embodiments above), further comprising, before determining a first and second actual outcome:
communicating the first betting matrix to a plurality of users, in which the plurality of users are each provided with an opportunity to make a bet comprising a selection of one of the plurality of selectable elements, in which each selectable element is capable of being selected by more than one of the plurality of users;
before determining a first and second actual outcome, receiving from each of the plurality of users a bet comprising a selection of at least one of the plurality of selectable indicia;
before determining a first and second actual outcome, communicating to the plurality of users the possible outcome indicia,
in which payouts on winning bets of the first user and the plurality of users are not paid from a common pari-mutuel pool.

A39. The method of embodiment A1 (and/or any other mutually consistent embodiments above),
in which the act of causing to be communicated to the first user a first betting matrix also comprises causing to be communicated to the first user (3) a second betting matrix comprising a second plurality of selectable elements arranged in rows and columns;
in which the act of causing to be communicated to the first user betting category information comprises causing to be communicated to the first user (4) second betting category information associated with the second betting matrix, the second category information comprising a third category of possible outcomes corresponding to the rows of the second betting matrix and a fourth category of possible outcomes corresponding to the columns of the second betting matrix;
in which the act of receiving a first bet also comprises receiving a selection by the first user of a selected one of the second plurality of selectable elements, the selected element of the second betting matrix being in a selected one of the rows and in a selected one of the columns of the second betting matrix;
in which the act of causing to be communicated to the first user possible outcome indicia comprises causing to be communicated to the first user second possible outcome indicia indicating a second plurality of possible outcomes associated with the rows and columns of the second betting matrix, the second possible outcome indicia comprising (1) for each row of the second betting matrix, indicia indicating a respective possible outcome of the third category corresponding to said row and (2) for each column of the second betting matrix, indicia indicating a respective possible outcome of the fourth category corresponding to said column, in which the selected element of the second betting matrix corresponds to both (a) the respective possible outcome of the third category corresponding to the selected row of the second betting matrix and (b) the respective possible outcome of the fourth category corresponding to the selected column of the second betting matrix.

A40. The method of embodiment A39 (and/or any other mutually consistent embodiments above), in which a payout is paid on the first bet if at least one of the following two criteria is determined to be satisfied:
(1) the possible outcomes corresponding to the selected row and selected column of the first betting matrix both actually occur; and
(2) the possible outcomes corresponding to the selected row and selected column of the second betting matrix both actually occur.

A41. The method of embodiment A39 (and/or any other mutually consistent embodiments above), further comprising paying a payout on the first bet only if both of the following criteria are determined to be satisfied:
(1) the possible outcomes corresponding to the selected row and selected column of the first betting matrix both actually occur; and
(2) the possible outcomes corresponding to the selected row and selected column of the second betting matrix both actually occur.

A42. The method of embodiment A1 (and/or any other mutually consistent embodiments above), in which:
the first bet concerns at least one event having a plurality of different winners determined in a plurality of different winning categories:
the first category comprises a first winning category associated with a first award;
the second category comprises a second winning category associated with a second award;
the possible outcomes corresponding to each row comprise a plurality of potential winners in the first winning category;
the possible outcomes corresponding to each column comprise a plurality of potential winners in the second winning category;
and in which the first bet cannot be winning bet unless the potential winner of the first award corresponding to the selected row actually wins in the first winning category and the potential winner corresponding to the selected column actually wins in the second winning category.

A43. The method of embodiment A42 (and/or any other mutually consistent embodiments above), in which the at least one event is selected from the group consisting of: the Academy Awards, the Emmy Awards, the Golden Globes, the Tony Awards, the People's Choice Awards, and the Grammy Awards.

A44. The method of embodiment A1 (and/or any other mutually consistent embodiments above), in which the information defining the elements in the first betting matrix is communicated to the first user after the first selected element is selected by the first user.

A45. The method of embodiment A1 (and/or any other mutually consistent embodiments above), in which the information defining the elements in the first betting matrix is communicated to the first user before the first selected element is selected by the first user.

A46. The method of embodiment A1 (and/or any other mutually consistent embodiments above), and in which the possible outcomes corresponding to the rows can occur independently of the possible outcomes corresponding to the columns.

A47. The method of embodiment A1 (and/or any other mutually consistent embodiments above), in which the first bet is confirmed independently of any other bet made by any other user.

A48. The method of embodiment A1 (and/or any other mutually consistent embodiments above), in which the first bet is a fixed odds bet having odds determined at or substantially at the time of the bet.

A49. The method of embodiment A1 (and/or any other mutually consistent embodiments above), further comprising determining whether the first bet is a winning bet, in which the first bet is a winning bet if at least one of the following conditions is satisfied:
(a) the possible outcome of the first category corresponding to the selected row actually occurs; and
(b) the possible outcome of the second category corresponding to the selected column actually occurs.

A50. The method of embodiment A1 (and/or any other mutually consistent embodiments above), further comprising:
before receiving the first bet, receiving from the first user a selection of an event on which to place a bet, in which the first bet comprises a bet concerning the first event.

A51. The method of embodiment A1 (and/or any other mutually consistent embodiments above), further comprising:
before receiving the first bet, receiving from the first user a selection of an event from among a plurality of events displayed to the first user, in which the first bet comprises a bet concerning the first event.

A52. The method of embodiment A1 (and/or any other mutually consistent embodiments above), in which the act of receiving the first bet comprises receiving from the user a wager amount associated with the bet.

A53. The method of embodiment A1 (and/or any other mutually consistent embodiments above), further comprising:
before causing to be communicated a confirmation that the first bet is in effect, causing to be communicated to the first user information about pre-defined odds for the first bet.

A54. The method of embodiment A1 (and/or any other mutually consistent embodiments above), in which odds for the first bet are equal to odds offered for bets corresponding to a selection of any other one of the plurality of selectable elements.

A55. A method comprising:
transmitting, by at least one computer processor electronically coupled to at least one memory, to a user device a list of events;
receiving, by the at least one processor, from the user device an activation of an event of the list of events;
transmitting, by the at least one processor, a betting matrix having at least one two sides to the user device;
receiving, by the at least one processor, from the user device an activation of at least one betting box of the betting matrix;
generating, by the at least one processor, side values for each side of the betting matrix;
receiving, by the at least one processor, an event outcome;
determining, by the at least one processor, whether the event outcome matches the at least one activated betting box;
if the event outcome is determined to match the at least one activated betting box, transmitting, by the at least one processor, to the user device a prize notification indicating a prize for matching the betting box to the event outcome.

A56. An apparatus comprising:
at least one processor; and
at least one memory, electronically coupled to the at least one processor, having instructions stored thereon which, when executed by the at least one processor, direct the at least one processor to perform the method of any of claims A1-A55.

A57. A machine-readable medium having instructions stored thereon, in which the instructions are configured to, when executed by at least one processor, direct the at least one processor to perform the method of any of claims A1-A55.

B1. A method of placing a wager on the score of a sporting event based on the single digit number represented by the score of each of the contestants where the bettor is wagering that the numbers for each team that they are assigned match the single digit of the score for each team at predetermined intervals.

B2. A method of embodiment B1 wherein the bettor uses an electronic terminal or web based application to initiate a wager comprising of the following steps:
(a) the player selects the sporting event to be used to determine the outcome;
(b) the player selects the intervals at which the score will be evaluated;
(c) the player selects the amount of money to be wagered;
(d) the player selects the amount of combinations that they would like to wager on for the selected event.

B3. A method of embodiment B2 wherein a ten by ten grid forming 100 individual boxes is displayed where after the player has completed the wagering process each column will be randomly assigned a number from 0 to 9 wherein all the numbers must be accounted for; and similarly each row will be will randomly be assigned a number from 0 to 9 wherein all the numbers must be accounted for.

B4. A method of embodiment B1 wherein the sporting event is a football, baseball, or basketball contest associated with a professional league or the National Collegiate Athletic Association.

B5. A method of embodiment B1 wherein a group of contests are linked together, and a payout schedule is comprised of having the correct numbers for multiple contests.

B6. A method of embodiment B5 wherein a progressive jackpot is created and will be won when a player has the winning numbers for a predetermined amount of contests.

B7. A method of embodiment B1 wherein the host site or location licensing the terminals or application adds a commission to the wager.

B8. A method of embodiment B5 wherein the commission reduces the true odds of the payout for each wager initiated.

B9. A method of embodiment B3 wherein the components representing each column and row are teams rather than numbers and the bettor is wagering on the team assigned to each row and the team assigned to each column that intersects with the box that they have selected with the results being determined by which two teams reach the final match of a given tournament.

Some embodiments have been described in terms of a client-server interaction to facilitate game play. In other embodiments, a game may be offered though a cloud based gaming environment. In such an embodiment, one cloud component may offer location services, another may offer accounting serves, another may offer random number generation services, and another may offer login services. An embodiment in such an environment may use these services to provide gaming functionality to users. For example, a gaming service may connect to a gaming cloud through which a user accesses gaming services. The gaming service may make a game available to users through the gaming cloud. User account information, monetary information, location information, and so on may be maintained by other cloud services for the gaming service.

Numerous embodiments are described in the present application and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves, and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g., sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth®, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Various embodiments can be configured to work in a network environment including a computer that is in communication (e.g., via a communications network) with one or more devices. The computer may communicate with the devices directly or indirectly, via any wired or wireless medium (e.g., the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium®, Centrino™, or Intel Core® processors, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the claims herein.

1. A method comprising:
receiving, by at least one processor of at least one computer, from a first user a request to submit a wager;
responsive to the request to submit a wager, causing to be communicated to the first user, by the at least one processor, a first betting matrix comprising a plurality of selectable elements arranged in rows and columns;
receiving, by the at least one processor, from the first user a first bet comprising a selection by the first user of a first one of the plurality of selectable elements, the first selected element being in a selected one of the rows and in a selected one of the columns;
responsive to receiving the first bet from the first user, causing to be communicated to the first user, by the at least one processor, a confirmation that the first bet is in effect, wherein a payout will be paid on the first bet if the first bet is a winning bet;
causing to be communicated to the first user, by the at least one processor, betting category information associated with the first betting matrix, the betting category information comprising a first category of possible outcomes corresponding to the rows and a second category of possible outcomes corresponding to the columns;
causing to be communicated to the first user, by the at least one processor, possible outcome indicia indicating a plurality of possible outcomes associated with the rows and columns of the first betting matrix, the possible outcome indicia comprising (1) for each row, indicia indicating a respective possible outcome of the first category corresponding to said row and (2) for each column, indicia indicating a respective possible outcome of the second category corresponding to said column, in which the first selected element corresponds to both (a) the respective possible outcome of the first category corresponding to the selected row and (b) the respective possible outcome of the second category corresponding to the selected column;
determining, by the at least one processor, a first actual outcome corresponding to at least one of the possible outcomes of the first category and a second actual outcome corresponding to at least one of the possible outcomes of the second category; and
responsive to determining a first actual outcome and a second actual outcome, cause to be communicated to the first user, by the at least one processor, information indicating whether the first bet is a winning bet.
